(19) United States
(12) Patent Application Publication
(10) Pub. No.: US 2026/0328005 A1
(43) Pub. Date: Oct. 22, 2026

(54) REBAR-TYING TOOL

(71) Applicant: MAKITA CORPORATION, ANJO-SHI (JP)

(72) Inventors: Kazunori KINOSHITA, Anjo-shi (JP); Yuta ASAKURA, Anjo-shi (JP)

(21) Appl. No.: 19/115,844

(22) PCT Filed: Aug. 10, 2023
(86) PCT No.: PCT/JP2023/029235

§ 371 Date: Mar. 27, 2025

(30) Foreign Application Priority Data
Oct. 12, 2022 (JP) 2022-163790

(51) Int. Cl. E04G 21/12; B65B 13/28

(52) U.S. Cl. CPC E04G 21/123; B65B 13/285

(57) ABSTRACT

A rebar-tying tool includes: a first brushless motor, which feeds a wire that is wound on a reel; a second brushless motor, which twists the wire; a head part, in which the reel, the first brushless motor, and the second brushless motor are disposed; a grip part, which extends downward from the head part; a foot part, which is disposed downward of the grip part and to which a battery is connectable; and a controller, which controls the first brushless motor and the second brushless motor. The controller is disposed in the grip part.

### CROSS-REFERENCE

This application is the US national stage of International Patent Application No. PCT/JP2023/029235 filed on Aug. 10, 2023, which claims priority to Japanese Patent Application No. 2022-163790 filed on Oct. 12, 2022.

### TECHNICAL FIELD

Techniques disclosed in the present specification relate to a rebar-tying tool.

### BACKGROUND ART

A known rebar-tying tool is disclosed in Japanese Laid-open Patent Publication No. 2019-112868.

### SUMMARY OF THE INVENTION

In embodiments in which a rebar-tying tool employs brushless motors as motive power supplies, a controller is required for controlling the brushless motors. The controller needs to be disposed at a suitable location to avoid undesired enlargement of the rebar-tying tool.

It is therefore one non-limiting object of the present teachings to disclose techniques for disposing a controller at a suitable location in a rebar-tying tool.

In one non-limiting aspect of the present teachings, a rebar-tying tool may comprise: a first brushless motor, which feeds a wire that is wound on a reel; a second brushless motor, which twists the wire; a head part, in which the reel, the first brushless motor, and the second brushless motor are disposed; a grip part, which extends downward from the head part; a foot part, which is disposed downward of the grip part and to which a battery is connectable; and a controller, which controls the first brushless motor and the second brushless motor. The controller may be disposed in the grip part.

According to the techniques disclosed in the present specification, a controller can be disposed at a suitable location in a rebar-tying tool.

### BRIEF DESCRIPTION OF THE DRAWINGS

FIG. 1 is an oblique view, viewed from the upper left and the rear, of a rebar-tying tool according to a first embodiment of the present teachings.

FIG. 2 is an oblique view, viewed from the upper right and the rear, of the rebar-tying tool according to the first embodiment.

FIG. 3 is an oblique view, viewed from the upper right and the rear, of the internal structure of one portion of the rebar-tying tool according to the first embodiment.

FIG. 4 is an oblique view, viewed from the upper left and the front, of the internal structure of one portion of the rebar-tying tool according to the first embodiment.

FIG. 5 is a diagram, viewed from the left, of the internal structure of the rebar-tying tool according to the first embodiment.

FIG. 6 is an exploded, oblique view, viewed from the front right and below, of a feed motor according to the first embodiment.

FIG. 7 is an exploded, oblique view, viewed from the front right and above, of the feed motor according to the first embodiment.

FIG. 8 is an exploded, oblique view, viewed from the upper left and the rear, of a twisting motor according to the first embodiment.

FIG. 9 is an exploded, oblique view, viewed from the upper left and the front, of the twisting motor according to the first embodiment.

FIG. 10 is a front view that shows a controller according to the first embodiment.

FIG. 11 is a rear view that shows the controller according to the first embodiment.

FIG. 12 is a diagram schematically showing a layout example of the controller according to the first embodiment.

FIG. 13 is a diagram schematically showing a layout example of the controller according to a second embodiment of the present teachings.

FIG. 14 is a diagram schematically showing a layout example of the controller according to a third embodiment of the present teachings.

FIG. 15 is a diagram schematically showing a layout example of the controller according to a fourth embodiment of the present teachings.

FIG. 16 is a diagram schematically showing a layout example of the controller according to a fifth embodiment of the present teachings.

FIG. 17 is an exploded, oblique view, viewed from the front right and below, of the feed motor according to the fifth embodiment.

FIG. 18 is an exploded, oblique view, viewed from the front right and above, of the feed motor according to the fifth embodiment.

FIG. 19 is an exploded, oblique view, viewed from the upper left and the rear, of the twisting motor according to the fifth embodiment.

FIG. 20 is an exploded, oblique view, viewed from the upper left and the front, of the twisting motor according to the fifth embodiment.

FIG. 21 is a front view that shows the controller according to the fifth embodiment.

FIG. 22 is a diagram schematically showing a layout example of the controller according to a sixth embodiment of the present teachings.

FIG. 23 is a diagram schematically showing a layout example of the controller according to a seventh embodiment of the present teachings.

FIG. 24 is a diagram schematically showing a layout example of the controller according to an eighth embodiment of the present teachings.

FIG. 25 is a diagram schematically showing a layout example of the controller according to a ninth embodiment of the present teachings.

FIG. 26 is a diagram schematically showing a layout example of the controller according to a tenth embodiment of the present teachings.

FIG. 27 is an oblique, schematic diagram that shows the controller according to the tenth embodiment.

FIG. 28 is an exploded, oblique view, viewed from the front right and below, of the feed motor according to the tenth embodiment.

FIG. 29 is an exploded, oblique view, viewed from the front right and above, of the feed motor according to the tenth embodiment.

FIG. 30 is an exploded, oblique view, viewed from the upper left and the rear, of the twisting motor according to the tenth embodiment.

FIG. 31 is an exploded, oblique view, viewed from the upper left and the front, of the twisting motor according to the tenth embodiment.

FIG. 32 is a diagram schematically showing a layout example of the controller according to an eleventh embodiment of the present teachings.

FIG. 33 is a diagram schematically showing a layout example of the controller according to a twelfth embodiment of the present teachings.

### DETAILED DESCRIPTION OF THE INVENTION

As was mentioned above, a rebar-tying tool may comprise: a first brushless motor, which feeds a wire that is wound on a reel; a second brushless motor, which twists the wire; a head part, in which the reel, the first brushless motor, and the second brushless motor are disposed; a grip part, which extends downward from the head part; a foot part, which is disposed downward of the grip part and to which a battery is connectable; and a controller, which controls the first brushless motor and the second brushless motor. The controller may be disposed in the grip part.

In the above-mentioned configuration, the controller is disposed at a suitable location in the rebar-tying tool.

In one or more embodiments, the controller may comprise a circuit board, which is elongated in a prescribed direction, and is disposed in the grip part so that the circuit board extends in an up-down direction.

In the above-mentioned configuration, the controller is suitably disposed in the grip part.

In one or more embodiments, the controller may comprise a first control circuit, which is mounted on the circuit board and controls the first brushless motor, and a second control circuit, which is mounted on the circuit board and controls the second brushless motor. The controller may be disposed in the grip part so that a first surface of the circuit board, on which the first control circuit and the second control circuit are mounted, faces leftward or rightward.

In the above-mentioned configuration, the controller is suitably disposed in the grip part.

In one or more embodiments, a rebar-tying tool may comprise: a first brushless motor, which feeds a wire that is wound on a reel; a second brushless motor, which is disposed more rearward than the first brushless motor and twists the wire; a head part, in which the reel, the first brushless motor, and the second brushless motor are disposed; a grip part, which extends downward from the head part; a foot part, which is disposed downward of the grip part and to which a battery is connectable; and a controller, which comprises a circuit board extending in a front-rear direction and controls the first brushless motor and the second brushless motor. A first control circuit, which comprises a first gate-driver circuit and a first inverter circuit for controlling the first brushless motor, may be mounted on a forward side of the circuit board; and a second control circuit, which comprises a second gate-driver circuit and a second inverter circuit for controlling the second brushless motor, may be mounted on a rearward side of the circuit board.

In the above-mentioned configuration, the distance between the first brushless motor and the first control circuit can be shortened, and the distance between the second brushless motor and the second control circuit can be shortened. Thereby, the controller is disposed at a suitable location in the rebar-tying tool.

In one or more embodiments, the controller may be disposed in the head part.

In the above-mentioned configuration, the controller is disposed at a suitable location in the rebar-tying tool.

In one or more embodiments, the controller may be disposed in the head part so that a first surface of the circuit board, on which the first control circuit and the second control circuit are mounted, faces leftward or rightward.

In the above-mentioned configuration, the controller is suitably disposed in the head part.

In one or more embodiments, the controller may be disposed in the head part so that a first surface of the circuit board, on which the first control circuit and the second control circuit are mounted, faces upward.

In the above-mentioned configuration, the controller is suitably disposed in the head part.

In one or more embodiments, the first brushless motor may comprise a first stator and a first rotor, which is disposed in the interior of the first stator; the first brushless motor may be disposed so that the rotational axis of the first rotor extends in an up-down direction; a first terminal, which (electrically) connects a plurality of (at least two) coils of the first stator, may be disposed at a rear portion of the first stator; a first sensor board, which detects rotation of the first rotor, may be disposed more downward than the first stator; the first terminal and the controller may be connected by a first power cable; and the first sensor board and the controller may be connected by a first signal cable.

In the above-mentioned configuration, the first brushless motor and the controller are disposed with a suitable positional relationship.

In one or more embodiments, the second brushless motor may comprise a second stator and a second rotor, which is disposed in the interior of the second stator; the second brushless motor may be disposed so that the rotational axis of the second rotor extends in a front-rear direction; a second terminal, which (electrically) connects a plurality of (at least two) coils of the second stator, may be disposed at a lower portion of the second stator; a second sensor board, which detects rotation of the second rotor, may be disposed more rearward than the second stator; the second terminal and the controller may be (electrically) connected by a second power cable; and the second sensor board and the controller may be (electrically) connected by a second signal cable.

In the above-mentioned configuration, the second brushless motor and the controller are disposed with a suitable positional relationship.

In one or more embodiments, at least one of the first brushless motor and the second brushless motor may have a sensor board, which detects rotation of a rotor. The sensor board may have an inverter circuit for motor driving.

In the above-mentioned configuration, the configuration of the controller is simplified, whereby the degrees of freedom for the arrangement of the controller increase.

In one or more embodiments, the controller may comprise a circuit board, which comprises: an inverter circuit for motor driving; and a heat sink, which is thermally connected to the inverter circuit.

In the above-mentioned configuration, temperature rises in the controller can be curtailed.

In one or more embodiments, the circuit board may comprise a heat sink, which is thermally connected to at least one of the first inverter circuit and the second inverter circuit.

In the above-mentioned configuration, temperature rises in the controller can be curtailed.

In one or more embodiments, the rebar-tying tool may further comprise a wireless-communication unit, which is provided in the grip part.

In the above-mentioned configuration, the wireless-communication unit and the controller are disposed with a suitable positional relationship.

In one or more embodiments, the rebar-tying tool may comprise a noise-removing member (noise-attenuating member), which removes (attenuates) electromagnetic noise on an electric-power line that electrically connects at least one of the first brushless motor and the second brushless motor with the controller.

In the above-mentioned configuration, in addition to disposing the brushless motors and the controller in a suitable positional relationship, the influence of electromagnetic noise can be curtailed.

In one or more embodiments, a rebar-tying tool may comprise: a first brushless motor, which feeds a wire that is wound on a reel; a second brushless motor, which twists the wire; a head part, in which the reel, the first brushless motor, and the second brushless motor are disposed; a grip part, which extends downward from the head part; a foot part, which is disposed downward of the grip part and to which a battery is connectable; and a controller, which controls the first brushless motor and the second brushless motor; the controller may be disposed in the foot part; wherein the controller may comprise: a circuit board; a controller case, which houses the circuit board; and a terminal, which connects the battery and the circuit board.

In the above-mentioned configuration, the controller is disposed at a suitable location in the rebar-tying tool.

Embodiments are explained below, with reference to the drawings. In the embodiments, positional relationships among the parts are explained using the terms left, right, front, rear, up, and down. These terms indicate relative position or direction, wherein the center of a rebar-tying tool 2 is the reference.

### First Embodiment

### Rebar-Tying Tool

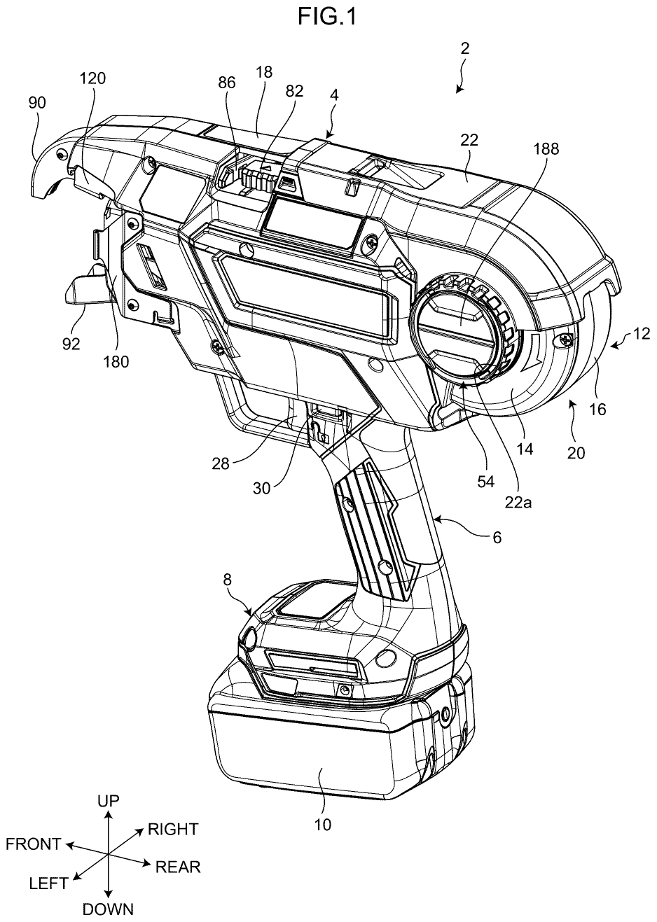

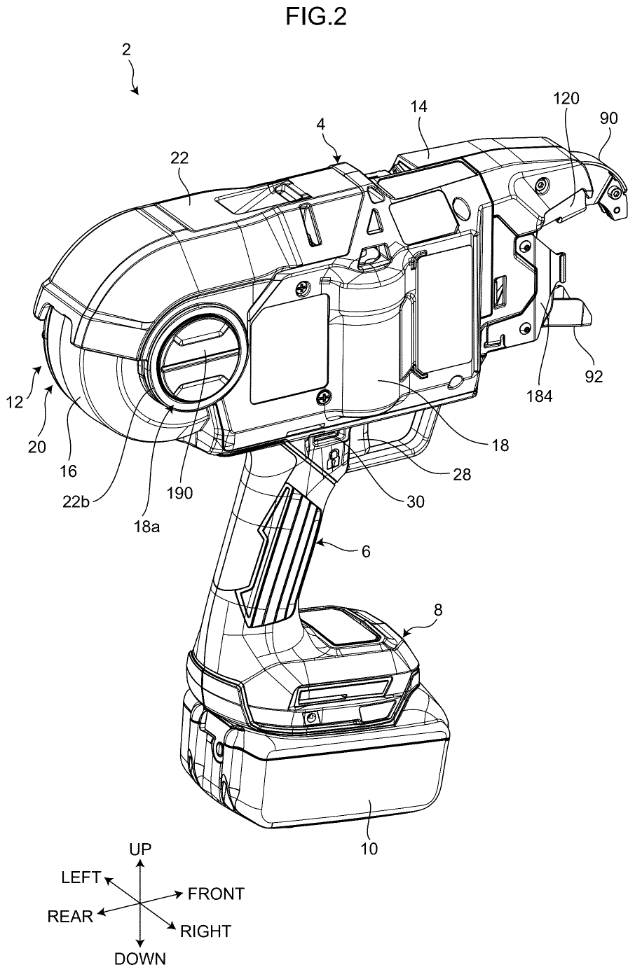

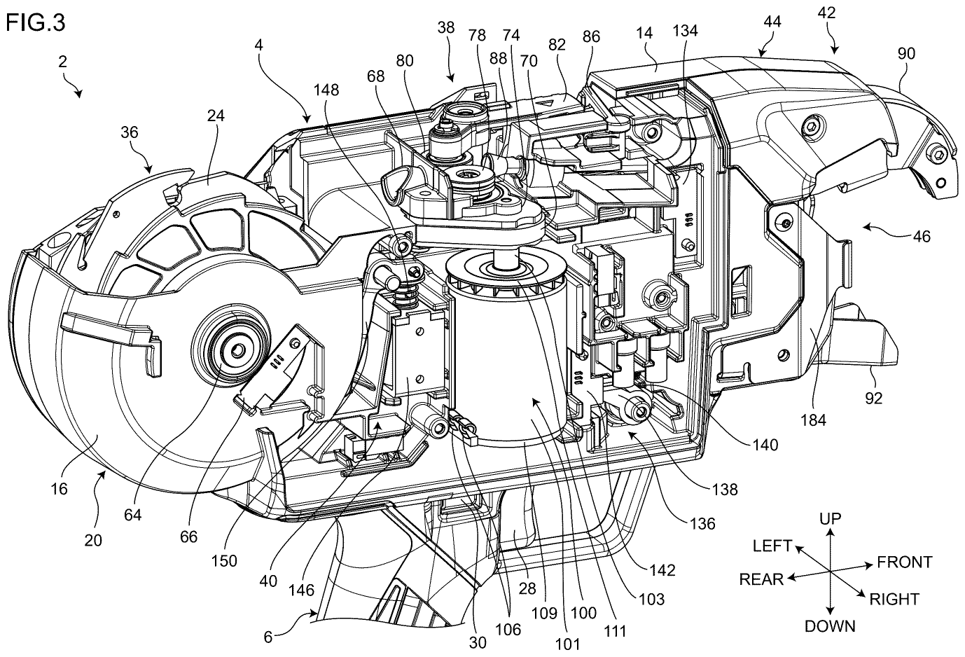

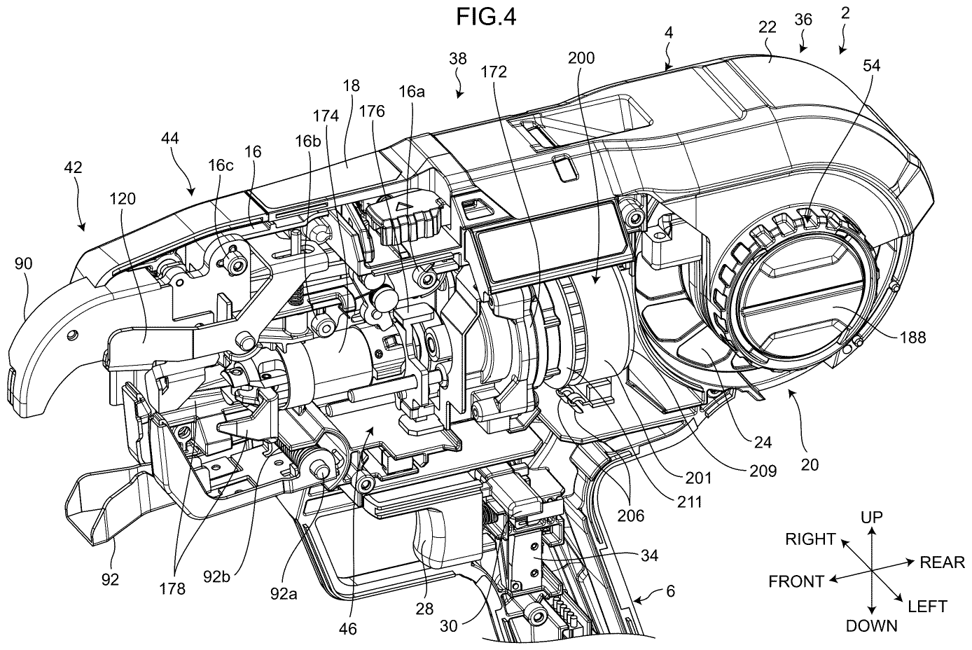

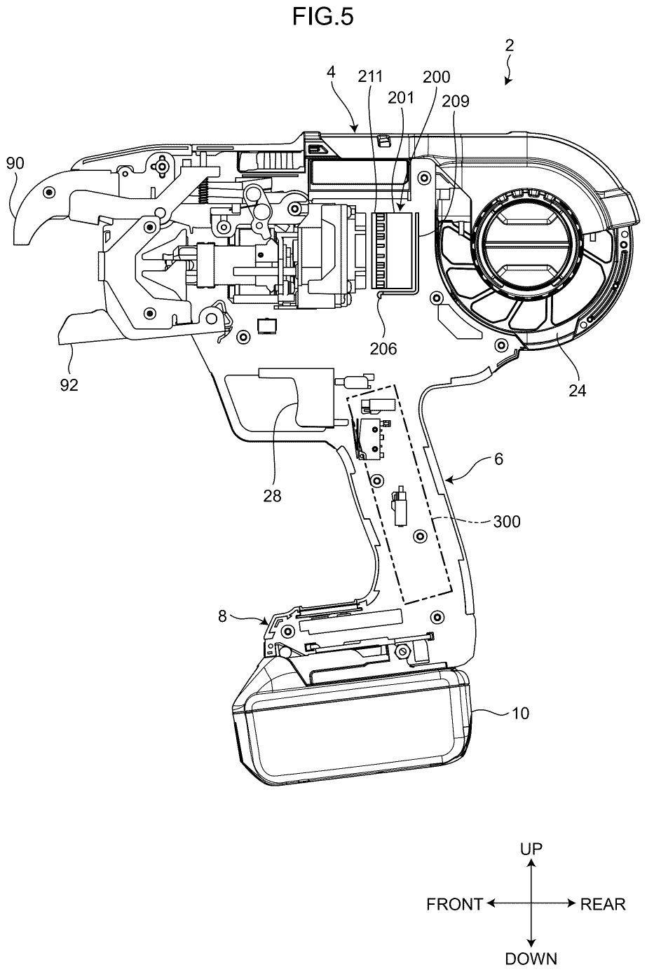

A first embodiment of the present teachings will now be described. FIG. 1 is an oblique view, viewed from the upper left and the rear, of the rebar-tying tool 2 according to the present (first) embodiment of the present teachings. FIG. 2 is an oblique view, viewed from the upper right and the rear, of the rebar-tying tool 2 according to the present embodiment. FIG. 3 is an oblique view, viewed from the upper right and the rear, of the internal structure of one portion of the rebar-tying tool 2 according to the present embodiment. FIG. 4 is an oblique view, viewed from the upper left and the front, of the internal structure of one portion of the rebar-tying tool 2 according to the present embodiment. FIG. 5 is a diagram, viewed from the left, of the internal structure of the rebar-tying tool 2 according to the present embodiment. The rebar-tying tool 2 is a power tool for tying a plurality of rebars using a wire.

The rebar-tying tool 2 comprises a feed motor 100, a twisting motor 200, a head part 4, a grip part 6, a foot part 8, and a controller 300. The wire is wound on a reel 24. The feed motor 100 feeds the wire that has been wound on the reel 24. The twisting motor 200 twists the wire that is fed from the feed motor 100. The reel 24, the feed motor 100, and the twisting motor 200 are disposed in the head part 4. The grip part 6 extends downward from the head part 4 and is gripped by a user. The foot part 8 is disposed downward of the grip part 6 and is connected to a battery 10. The battery 10 is detachable from a lower portion of the foot part 8. The battery 10 is a slidable-type battery that is detachable by sliding the battery 10 relative to the foot part 8. The battery 10 is a rechargeable lithium-ion battery that can be charged with a charger. When the battery 10 is connected to the foot part 8, electric power is supplied from the battery 10 to the rebar-tying tool 2. Battery terminals, which electrically connect to the battery 10, are provided on a lower surface of the foot part 8. The battery terminals are electrically connected to the controller 300. The controller 300 controls the feed motor 100 and the twisting motor 200. The controller 300 is disposed in the grip part 6. As used herein, the expression “twists the wire” is intended to mean that two portions of a wire are twisted together to secure or fasten the wire that has been wound (looped) around at least two rebars.

The rebar-tying tool 2 comprises a housing 12. The housing 12 comprises a left housing 14, a right housing 16, and a side-surface cover housing 18. The left housing 14, the right housing 16, and the side-surface cover housing 18 are each made of a synthetic resin (polymer). The left housing 14, the right housing 16, and the side-surface cover housing 18 can respectively be a plurality of housing plates that constitutes the housing 12. The left housing 14 may be integrally formed by the external shape of the left-half portion of the head part 4, the external shape of the left-half portion of the grip part 6, and the external shape of the left-half portion of the foot part 8. The right housing 16 may be integrally formed by one portion of the external shape of the right-half portion of the head part 4, the external shape of the right-half portion of the grip part 6, and the external shape of the right-half portion of the foot part 8. The left housing 14 is fixed to the right housing 16 by a plurality of screws. One portion of the external shape of the right-half portion of the head part 4 is formed by the side-surface cover housing 18. The side-surface cover housing 18 is fixed to the right housing 16 by a plurality of screws. A reel-housing chamber 20, which houses the reel 24, is formed rearward of the head part 4. The reel-housing chamber 20 is covered from above by a reel cover 22. The reel cover 22 is held on the head part 4 via circular-ring-shaped mounting parts 22a, 22b, which are respectively provided on the left and the right of the reel cover 22; the reel-housing chamber 20 opens and closes by pivoting the reel cover 22 relative to the head part 4 about a pivot axis that extends in the left-right direction.

A trigger 28, which is pullable by the user, and a trigger lock 30, which is disposed rearward of the trigger 28 and is switchable between a state that permits and a state that prohibits the pulling of the trigger 28, are provided at a forward upper portion of the grip part 6. The trigger 28 is held between the left housing 14 and the right housing 16 so that the trigger 28 is slidable in a front-rear direction relative to the grip part 6. The trigger 28 is biased forward by a compression spring, which is held between the left housing 14 and the right housing 16. A trigger switch 34 is disposed at an upper portion of the interior of the grip part 6. The trigger switch 34 is electrically connected to the controller 300. When the user places their finger on the trigger 28 and pulls the trigger 28 against the biasing force of the compression spring, the trigger 28 moves rearward and depresses the trigger switch 34. When the user removes their finger from the trigger 28, the trigger 28 moves forward owing to the biasing force of the compression spring, thereby separating from the trigger switch 34.

The trigger lock 30 is held between the left housing 14 and the right housing 16 so that the trigger lock 30 is slidable in the left-right direction relative to the grip part 6. The trigger lock 30 is movable between a permitted position, which permits the trigger 28 to be pulled, and a prohibited position, which prohibits the trigger 28 from being pulled. The trigger 28 is movable rearward while the trigger lock 30 is in the permitted position. That is, the user can pull the trigger 28 while the trigger lock 30 is in the permitted position. When the user pushes in the trigger lock 30 from the left side of the grip part 6 from the state in which the trigger lock 30 is in the permitted position, the trigger lock 30 slides in the right direction and moves to the prohibited position. The trigger lock 30 opposes a stopper on the trigger 28 while the trigger lock 30 is in the prohibited position. In this state, the trigger lock 30 abuts the trigger 28 when the trigger 28 moves rearward, and the trigger 28 is prohibited from moving any further rearward. That is, the user is prohibited from pulling the trigger 28 while the trigger lock 30 is in the prohibited position.

The head part 4 primarily comprises a housing mechanism 36, a feed mechanism 38, a brake mechanism 40, a guide mechanism 42, a cutting mechanism 44, and a twisting mechanism 46.

The housing mechanism 36 is disposed in a rear portion of the head part 4 and holds the reel 24, which is housed in the reel-housing chamber 20, in a detachable manner. In the reel-housing chamber 20, the reel 24 is supported in a rotatable manner by the housing mechanism 36.

The housing mechanism 36 comprises a cam member 54, which is provided on the left side of the reel-housing chamber 20. The cam member 54 holds the reel cover 22. In addition, the housing mechanism 36 comprises a bearing 64, which supports the reel 24, and a magnetic sensor 66. The reel 24 is held, via the bearing 64, on the right housing 16 in a rotatable manner. The magnetic sensor 66 is disposed on the outer side of the right housing 16. The magnetic sensor 66 is electrically connected to the controller 300. The magnetic sensor 66 is mounted on the right housing 16. The magnetic sensor 66 is sandwiched between the right housing 16 and the side-surface cover housing 18 in the state in which the side-surface cover housing 18 is mounted on the right housing 16. When the reel 24 rotates, a sensor magnet provided on the reel 24 rotates integrally with the reel 24, and the magnet field detected by the magnetic sensor 66 fluctuates. The controller 300 can detect the rotation of the reel 24 based on the fluctuations in the magnet field from the sensor magnet detected by the magnetic sensor 66. It is noted that the rotation sensor, which detects the rotation of the reel 24, does not need to be the magnetic sensor 66. A photocoupler (optical sensor) is an illustrative example of alternative type of sensor that can be used as the rotation sensor that detects the rotation of the reel 24.

The feed mechanism 38 is disposed in an upper portion of the head part 4 in the vicinity of the center thereof in the front-rear direction and feeds the wire supplied from the reel 24 of the housing mechanism 36 to the guide mechanism 42, which is forward of the head part 4. The feed mechanism 38 comprises a guide member 68, a cover member 70, the feed motor 100, a speed-reducing mechanism 74, a main driver gear 78, a follower gear 80, a release lever 82, and a lock lever 86.

The main driver gear 78 is coupled to the feed motor 100 via the speed-reducing mechanism 74. The feed motor 100 is a direct-current brushless motor. The feed motor 100 is electrically connected to the controller 300. The controller 300 can control the operation of the feed motor 100. The main driver gear 78 is held in the cover member 70 via a bearing in a rotatable manner. The speed-reducing mechanism 74 is housed in a space in the interior of the cover member 70. That is, viewed from the cover member 70, the speed-reducing mechanism 74 is disposed on the feed motor 100 side, generates a reduced-speed rotation (as compared to the speed of the rotation of the feed motor 100), and transmits the reduced-speed rotation to the main driver gear 78.

The guide member 68 has a through hole that guides the wire, which is pulled from the reel 24, toward the main driver gear 78 and the follower gear 80.

The follower gear 80 is supported on the release lever 82 in a rotatable manner. The release lever 82 is supported on the right housing 16 in a swingable (pivotable) manner. The wire, which is sandwiched between the main driver gear 78 and the follower gear 80, is fed toward the guide mechanism 42, and the wire is pulled from the reel 24. The main driver gear 78 or the follower gear 80 can be a feed roller that feeds the wire.

When the user of the rebar-tying tool 2 depresses the release lever 82, the release lever 82 swings (pivots) and the follower gear 80 separates from the main driver gear 78. The release lever 82 is held in the depressed state. When the wire extending from the reel 24 is set in the feed mechanism 38, the user depresses the release lever 82 to separate the follower gear 80 from the main driver gear 78, and in that state the user passes the tip of the wire, which has been pulled from the reel 24, through the through hole of the guide member 68 and disposes the tip of the wire between the main driver gear 78 and the follower gear 80. Furthermore, when the user causes the lock lever 86 to swing (pivot) in a direction away from the release lever 82, the engagement of the lock lever 86 is released, the release lever 82 swings, the follower gear 80 engages with the main driver gear 78, and the wire is sandwiched between the main driver gear 78 and the follower gear 80.

The guide mechanism 42 is disposed at a front portion of the head part 4 and guides the wire, which is fed from the feed mechanism 38, in a circular-ring shape around a plurality of rebars. The guide mechanism 42 comprises a guide pipe 88, an upper-side curl guide 90, and a lower-side curl guide 92. An end portion on the rearward side of the guide pipe 88 opens to face the space between the main driver gear 78 and the follower gear 80 of the feed mechanism 38. The wire fed from the feed mechanism 38 is fed into the interior of the guide pipe 88. An end portion on the forward side of the guide pipe 88 opens toward the interior of the upper-side curl guide 90. The wire, which is fed out from the guide pipe 88, is guided toward a swinging member (pivotable member) 120. The swinging member 120 cuts the wire by shearing the wire. The wire is fed toward the lower-side curl guide 92.

The lower-side curl guide 92 guides the wire fed from the front end of the upper-side curl guide 90. The wire, which is fed from rearward of the lower-side curl guide 92 to rearward of the upper-side curl guide 90, is once again fed from forward of the upper-side curl guide 90 to forward of the lower-side curl guide 92.

A magnetic sensor 134 is mounted on the right housing 16 forward of the head part 4. The magnetic sensor 134 is electrically connected to the controller 300. When the user sets (places) the upper-side curl guide 90 and the lower-side curl guide 92 of the rebar-tying tool 2 around a plurality of rebars and the plurality of rebars is pressed against the upper-side curl guide 90, the upper-side curl guide 90 swings (pivots), and a sensor magnet, which is mounted on the upper-side curl guide 90, is disposed at (moved to) a location away from the magnetic sensor 134. The controller 300 can detect whether the upper-side curl guide 90 is pressed against the plurality of rebars based on a detection signal from the magnetic sensor 134.

Screw bosses 16a, 16b, 16c, which are used when mounting the left housing 14 onto the right housing 16, are formed on the right housing 16 forward of the head part 4. The upper-side curl guide 90 can be mounted on the right housing 16, without increasing the part count, by employing the screw bosses 16a, 16b, 16c—which are used when mounting the left housing 14 onto the right housing 16—to mount the upper-side curl guide 90 on the right housing 16. In addition, the upper-side curl guide 90 can be accurately positioned relative to the right housing 16. Furthermore, the locations at which the screw bosses 16a, 16b, 16c are formed are the relatively stronger locations of the right housing 16, and therefore, increased durability thereof can be ensured, even when the load, which is caused by the plurality of the rebars impacting the upper-side curl guide 90, is transmitted from the upper-side curl guide 90 to the right housing 16.

The lower-side curl guide 92 is supported on the left housing 14 and the right housing 16 via a swing (pivot) shaft 92a in a swingable (pivotable) manner. The lower-side curl guide 92 is swingable between a closed state and an open state. The lower-side curl guide 92 is biased in a closing direction by a torsion spring 92b. When the user is to use the rebar-tying tool 2, the lower-side curl guide 92 is put in the closed state. If the wire becomes adversely tangled in the twisting mechanism 46 while the user is using the rebar-tying tool 2, the user can remove the wire that is tangled in the twisting mechanism 46 by opening the lower-side curl guide 92 against the biasing force of the torsion spring 92b.

An open/close detection mechanism 136, which detects the open/close state of the lower-side curl guide 92, is provided at a lower-front portion of the head part 4. The open/close detection mechanism 136 is mounted on the right housing 16. The open/close detection mechanism 136 comprises an open/close detection member 138, a compression spring 140, and a magnetic sensor 142. The open/close detection member 138 is supported on the right housing 16 in a swingable (pivotable) manner. In addition, the open/close detection member 138 is biased upward in a swing (pivot) direction by the compression spring 140, which is held on the right housing 16. A sensor magnet is mounted on the open/close detection member 138. The magnetic sensor 142 is fixed to the right housing 16. The magnetic sensor 142 is electrically connected to the controller 300. In the closed state, the lower-side curl guide 92 pushes the open/close detection member 138 down, and the sensor magnet of the open/close detection member 138 is disposed at a location opposing the magnetic sensor 142. When the user opens the lower-side curl guide 92, the lower-side curl guide 92 separates from the open/close detection member 138. Thereby, the open/close detection member 138 swings, and the sensor magnet of the open/close detection member 138 is disposed at (moved to) a location away from the magnetic sensor 142. The controller 300 can detect the open/close state of the lower-side curl guide 92 based on a detection signal from the magnetic sensor 142. It is noted that a metal side plate 180, which is mounted on the left housing 14, is provided on the left housing 14 in the vicinity of the lower-side curl guide 92. A metal side plate 184, which is mounted on the right housing 16, is provided on the right housing 16 in the vicinity of the lower-side curl guide 92.

The upper-side curl guide 90 feeds the wire downward from forward and upward of the plurality of rebars, and the lower-side curl guide 92 feeds the wire, which has been fed from the upper-side curl guide 90, upward from rearward and downward of the plurality of rebars. Thereby, the wire fed from the feed mechanism 38 is wound (looped) in a circular-ring shape around the plurality of rebars. When the feed mechanism 38 has fed the wire by a wire feeding amount, which is set by the user, the feed mechanism 38 stops the feed motor 100 and thereby stops feeding the wire.

The brake mechanism 40, in coordination with the feed mechanism stopping the feeding of the wire, stops the rotation of the reel 24. The brake mechanism 40 comprises a solenoid 146, a compression spring 148, and a brake member 150. The solenoid 146 is electrically connected to the controller 300. The controller 300 can control the operation of the solenoid 146. The brake member 150 is mounted on the right housing 16 in a swingable (pivotable) manner. An output shaft of the solenoid 146, which advances and retracts in the up-down direction, is coupled to the brake member 150. In addition, the brake member 150 is biased by the compression spring 148 in the swing direction away from the reel 24. The brake member 150 is separated, from the portion at which it engages with the reel 24, by the biasing force of the compression spring 148 in the state in which electrical current is not being supplied to the solenoid 146. The solenoid 146 drives the brake member 150, causing a torque to act on the brake member 150 in the state in which electrical current is supplied to the solenoid 146, and thereby the brake member 150 swings and engages with the engaging portion of the reel 24. When the feed mechanism 38 is to feed the wire, the controller 300 causes the brake member 150 to separate from the engaging portion of the reel 24 without supplying electrical current to the solenoid 146. Thereby, the reel 24 can rotate freely, and the feed mechanism 38 can pull the wire from the reel 24. In addition, when the feed mechanism 38 is to stop feeding the wire, the controller 300 causes the brake member 150 to engage with the engaging portion of the reel 24 by supplying electric current to the solenoid 146. Thereby, the reel 24 is prohibited from rotating. Therefore, it is possible to prevent a disadvantageous loosening of the wire between the reel 24 and the feed mechanism 38, i.e. in case the reel 24 were to continue to rotate owing to inertia even though the feed mechanism 38 has stopped feeding the wire.

The brake mechanism 40 is disposed outside of the right housing 16 and is housed in a space that is partitioned by the right housing 16 and the side-surface cover housing 18. The twisting motor 200 of the twisting mechanism 46, which is described below, is disposed forward of the reel 24.

The solenoid 146 is arranged so that the longitudinal direction thereof is substantially parallel to a direction that is tangential to the rotational motion of the reel 24 at the location most proximate to the solenoid 146. In addition, the solenoid 146 is disposed so that the longitudinal direction thereof is at least substantially parallel to the rotational axis of the feed motor 100.

The cutting mechanism 44 is disposed at the front portion of the head part 4 and cuts the wire in the state in which (i.e. after) the wire has been wound around the plurality of rebars. The cutting mechanism 44 is integrated with the upper-side curl guide 90 of the guide mechanism 42.

The twisting mechanism 46 is disposed (extends) from the front portion to an intermediate portion of the head part 4 in the front-rear direction and ties the plurality of rebars using the wire by twisting the wire that was wound around the plurality of rebars. The twisting mechanism 46 comprises: the twisting motor 200; a speed-reducing mechanism 172; a sleeve 174; a screw shaft (not shown), which is disposed in the interior of the sleeve 174; a pusher 176; and hooks 178.

The twisting motor 200 is a direct-current brushless motor. The twisting motor 200 is electrically connected to the controller 300. The controller 300 can control the operation of the twisting motor 200. The rotation of the rotor 200 of the twisting motor 200 is transmitted to the screw shaft via the speed-reducing mechanism 172. The twisting motor 200 is rotatable in a forward rotational direction and a reverse (opposite) rotational direction; the screw shaft is also rotatable in the forward rotational direction and the reverse (opposite) rotational direction in accordance with the rotation of the twisting motor 200. The sleeve 174 is disposed around the screw shaft so as to cover it. In the state in which rotation of the sleeve 174 is prohibited, when the screw shaft rotates in the forward direction, the sleeve 174 moves forward, and when the screw shaft rotates in the reverse direction, the sleeve 174 moves rearward. In addition, in the state in which rotation of the sleeve 174 is permitted, when the screw shaft rotates, the sleeve 174 rotates together with the screw shaft. When the sleeve 174 moves forward, the pusher 176 moves forward, and when the sleeve 174 moves rearward, the pusher 176 moves rearward. When the sleeve 174 advances from an initial position to a prescribed position, the pusher 176 pushes a lower portion of the cutting mechanism 44 forward, and thereby the swinging member 120 swings. Conversely, when the sleeve 174 retracts to a prescribed position from the position to which it had advanced, the pusher 176 pushes the lower portion of the cutting mechanism 44 rearward, and thereby the swinging member 120 swings (pivots). The hooks 178 are provided at the front end of the sleeve 174 and open and close in accordance with the location of the sleeve 174 in the front-rear direction. When the sleeve 174 moves forward, the hooks 178 close and grip the wire. Conversely, when the sleeve 174 moves rearward, the hooks 178 open and release the wire.

The controller 300 causes the twisting motor 200 to rotate in the state in which the wire has been wound around the plurality of rebars. At this time, rotation of the sleeve 174 is prohibited, and the pusher 176 and the hooks 178 advance as the sleeve 174 advances owing to the rotation of the screw shaft; thereby, the hooks 178 close to grip the wire as the wire is cut by the cutting mechanism 44. Then, when rotation of the sleeve 174 is permitted, the hooks 178 rotate as the sleeve 174 rotates owing to the rotation of the screw shaft.

Thereby, the wire is twisted and the plurality of rebars is tied together. The strength with which the wire is twisted can be set in advance by the user. When the wire is twisted to the set twisting strength, the controller 300 causes the twisting motor 200 to rotate in the reverse direction. At this time, rotation of the sleeve 174 is prohibited, and the hooks 178 retract while opening as the sleeve 174 retracts owing to the rotation of the screw shaft, thereby releasing the wire. In addition, the pusher 176 retracts as the sleeve 174 retracts, and thereby the cutting mechanism 44 returns to its initial state. Thereafter, rotation of the sleeve 174 is permitted, and the hooks 178 return to their initial angle as the pusher 176 and the hooks 178 retract to their initial positions.

When the user sets (places) the rebar-tying tool 2 so that the plurality of rebars is located between the upper-side curl guide 90 and the lower-side curl guide 92 and pulls the trigger 28, the rebar-tying tool 2 performs one sequence of operations, in which the wire is wound around the plurality of rebars by a first operation performed by the feed mechanism 38, the brake mechanism 40, and the guide mechanism 42; then, the wire is cut and portions f the wire that has been wound around the plurality of rebars are twisted together by a second operation performed by the cutting mechanism 44 and the twisting mechanism 46.

With regard to the rebar-tying tool 2 of the present embodiment, an elastic cover 188 is provided on the outer surface of the housing mechanism 36, which holds the mounting part 22a of the reel cover 22, and an elastic cover 190 is provided on a cover-holding part 18a of the side-surface cover housing 18, which holds the mounting part 22b of the reel cover 22. The elastic covers 188, 190 are both composed of an elastic material such as an elastomer. Thereby, when the rebar-tying tool 2 is laid horizontally, the elastic covers 188, 190 act as bumpers to protect the internal components of the rebar-tying tool 2 from impacts.

### Motor

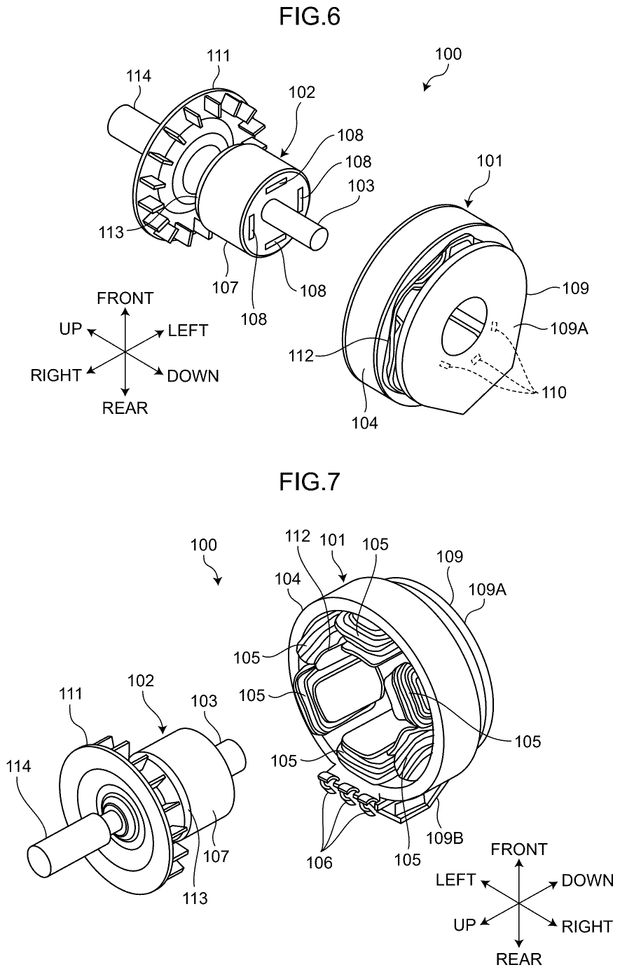

FIG. 6 is an exploded, oblique view, viewed from the front right and below, of the feed motor 100 according to the present embodiment. FIG. 7 is an exploded, oblique view, viewed from the front right and above, of the feed motor 100 according to the present embodiment. The feed motor 100 generates a rotational force. The feed motor 100 is an electric motor. The feed motor 100 is preferably an inner-rotor-type brushless motor. The feed motor 100 comprises a stator 101, a rotor 102, and a rotor shaft 103. The stator 101 is disposed around the rotor 102. The rotor 102 is disposed around the rotor shaft 103. The rotor shaft 103 is fixed to the rotor 102. The rotor 102 and the rotor shaft 103 rotate relative to the stator 101. The rotor 102 and the rotor shaft 103 rotate about a rotational axis that extends in the up-down direction.

The stator 101 comprises a stator core 104, an insulator 112, and coils 105. The stator core 104 comprises a circular-ring-shaped yoke and teeth, which protrude radially inward from an inner circumferential surface of the yoke. The stator core 104 is disposed radially outward of (surrounding) the rotor 102. The stator core 104 comprises a plurality of laminated steel sheets. Each of the steel sheets is a sheet made of a metal in which iron is the main component. The stator core 104 has a tube shape. The teeth of the stator core 104 respectively support the coils 105. In the present embodiment, six teeth are provided.

The coils 105 are mounted on the stator core 104 via (around) the insulator 112. The coils 105 are respectively wound around the teeth of the stator core 104 via (around) the insulator 112. The insulator 112 is an electrically insulating member that is made of a synthetic resin (polymer). The coils 105 and the stator core 104 are electrically insulated from each other by the insulator 112. Pairs of the coils 105 are electrically connected to each other via respective busbars and terminals 106 (fusing terminals). In the present embodiment, six of the coils 105 are provided. Two of the coils 105 serve as U-phase coils, two of the coils 105 serve as V-phase coils, and two of the coils 105 serve as W-phase coils. Three of the terminals 106 are provided. The first terminal 106 electrically connects the pair of U-phase coils. The second terminal 106 electrically connects the pair of V-phase coils. The third terminal 106 electrically connects the pair of W-phase coils. In the present embodiment, the three terminals 106 are disposed at a rear portion of the stator core 104. The three terminals 106 are disposed lined up in the left-right direction.

The rotor 102 comprises a rotor core 107, rotor magnets 108, and a balance-correcting plate 113. The rotor core 107 and the rotor shaft 103 are each made of steel. The rotor shaft 103 is disposed in a through hole that is provided in the center of the rotor core 107. The rotor core 107 and the rotor shaft 103 are fixed to each other. An upper portion of the rotor shaft 103 protrudes upward from an upper end surface of the rotor core 107. An output pinion 114 is fixed to an upper portion of the rotor shaft 103. The rotational force of the rotor shaft 103 is output via the output pinion 114. A lower portion of the rotor shaft 103 protrudes downward from a lower-end surface of the rotor core 107. The rotor magnets 108 are fixed to the rotor core 107. The rotor magnets 108 are respectively disposed in the interiors of magnet holes provided in the rotor core 107. In the present embodiment, four of the rotor magnets 108 are disposed in the circumferential direction of the rotor core 107. The balance-correcting plate 113 is fixed to the upper-end surface of the rotor core 107. The balance-correcting plate 113 is made of brass. The balance-correcting plate 113 corrects the rotational balance of the rotor 102 to improve the rotational balance of the rotor 102.

A sensor board 109 is mounted on the stator 101. The sensor board 109 comprises: a circular-ring-shaped circuit-board part 109A, which opposes the lower-end surface of the rotor core 107; and a support part 109B, which is connected to the rear portion of the stator core 104. Magnetic sensors 110 are disposed on the circuit-board part 109A. At least one portion of the circuit-board part 109A opposes the rotor magnets 108. The magnetic sensors 110 detect the position of the rotor 102 in the rotational direction by detecting the location of the rotor magnets 108 based on magnetic flux.

A fan 111 is fixed to an upper-end portion of the rotor shaft 103. When the rotor shaft 103 rotates, the fan 111 rotates together with the rotor shaft 103. The rotation of the fan 111 generates an airflow for cooling the feed motor 100.

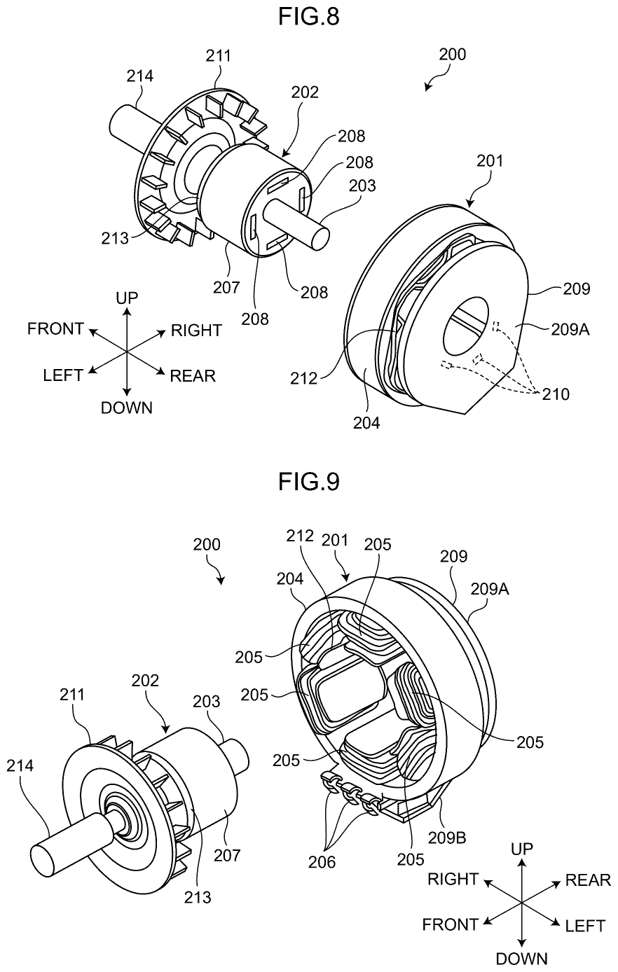

FIG. 8 is an exploded, oblique view, viewed from the upper left and the rear, of the twisting motor 200 according to the present embodiment. FIG. 9 is an exploded, oblique view, viewed from the upper left and the front, of the twisting motor 200 according to the present embodiment. The twisting motor 200 generates a rotational force. The twisting motor 200 is an electric motor. The twisting motor 200 is preferably an inner-rotor-type brushless motor. The twisting motor 200 comprises a stator 201, a rotor 202, and a rotor shaft 203. The stator 201 is disposed around the rotor 202. The rotor 202 is disposed around the rotor shaft 203. The rotor shaft 203 is fixed to the rotor 202. The rotor 202 and the rotor shaft 203 rotate relative to the stator 201. The rotor 202 and the rotor shaft 203 rotate about a rotational axis that extends in the front-rear direction.

The stator 201 comprises a stator core 204, an insulator 212, and coils 205. The stator core 204 comprises a circular-ring-shaped yoke and teeth, which protrude radially inward from an inner circumferential surface of the yoke. The stator core 204 is disposed radially outward of (surrounding) the rotor 202. The stator core 204 comprises a plurality of laminated steel sheets. Each of the steel sheets is a sheet made of a metal in which iron is the main component. The stator core 204 has a tube shape. The teeth of the stator core 204 respectively support the coils 205. In the present embodiment, six teeth are provided.

The coils 205 are mounted on the stator core 204 via (around) the insulator 212. The coils 205 are respectively wound around the teeth of the stator core 204 via (around) the insulator 212. The insulator 212 is an electrically insulating member that is made of a synthetic resin (polymer). The coils 205 and the stator core 204 are electrically insulated from each other by the insulator 212. Pairs of the coils 205 are connected to each other via respective busbars and terminals 206 (fusing terminals). In the present embodiment, six of the coils 205 are provided. Two of the coils 205 serve as U-phase coils, two of the coils 205 serve as V-phase coils, and two of the coils 205 serve as W-phase coils. Three of the terminals 206 are provided. The first terminal 206 electrically connects the pair of U-phase coils. The second terminal 206 electrically connects the pair of V-phase coils. The third terminal 206 electrically connects the pair of W-phase coils. In the present embodiment, the three terminals 206 are disposed at a lower portion of the stator core 204. The three terminals 206 are disposed lined up in the left-right direction.

The rotor 202 comprises a rotor core 207, rotor magnets 208, and a balance-correcting plate 213. The rotor core 207 and the rotor shaft 203 are each made of steel. The rotor shaft 203 is disposed in a through hole that is provided in the center of the rotor core 207. The rotor core 207 and the rotor shaft 203 are fixed to each other. A front portion of the rotor shaft 203 protrudes forward from a front-end surface of the rotor core 207. An output pinion 214 is fixed to the front portion of the rotor shaft 203. The rotational force of the rotor shaft 203 is output via the output pinion 214. A rear portion of the rotor shaft 203 protrudes rearward from a rear-end surface of the rotor core 207. The rotor magnets 208 are fixed to the rotor core 207. The rotor magnets 208 are respectively disposed in the interiors of magnet holes provided in the rotor core 207. In the present embodiment, four of the rotor magnets 208 are disposed in the circumferential direction of the rotor core 207. The balance-correcting plate 213 is fixed to the front-end surface of the rotor core 207. The balance-correcting plate 213 is made of brass. The balance-correcting plate 213 corrects the rotational balance of the rotor 202 to improve the rotational balance of the rotor 202.

A sensor board 209 is mounted on the stator 201. The sensor board 209 comprises: a circular-ring-shaped circuit-board part 209A, which opposes the rear-end surface of the rotor core 207; and a support part 209B, which is connected to the lower portion of the stator core 204. Magnetic sensors 210 are disposed on the circuit-board part 209A. At least one portion of the circuit-board part 209A opposes the rotor magnets 208. The magnetic sensors 210 detect the position of the rotor 202 in the rotational direction by detecting the location of the rotor magnets 208 based on magnetic flux.

A fan 211 is fixed to the front portion of the rotor shaft 203. When the rotor shaft 203 rotates, the fan 211 rotates together with the rotor shaft 203. The rotation of the fan 211 generates an airflow for cooling the twisting motor 200.

### Controller

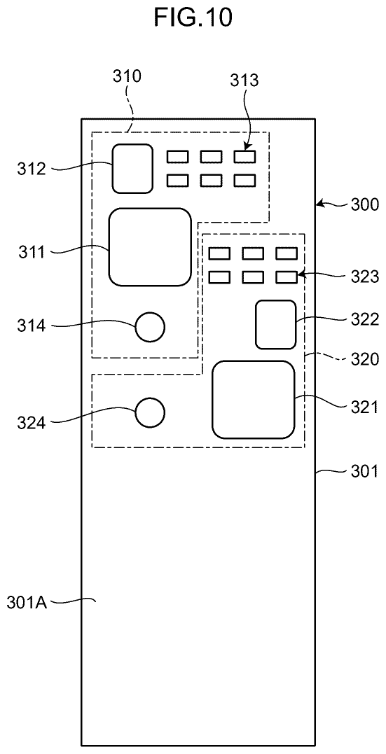

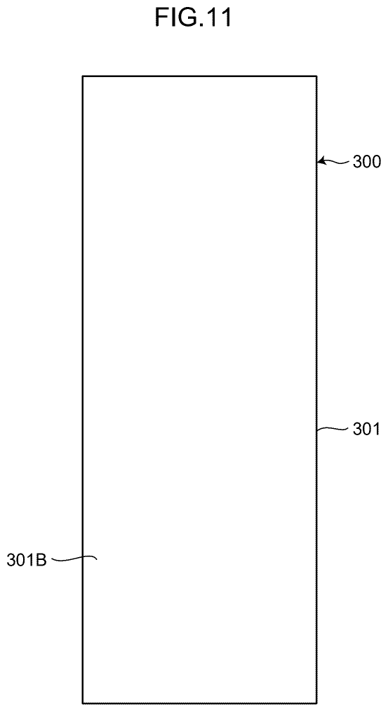

FIG. 10 is a front view that shows the controller 300 according to the present embodiment. FIG. 11 is a rear view that shows the controller 300 according to the present embodiment. The controller 300 comprises: a circuit board 301; a first control circuit 310, which is mounted on the circuit board 301; and a second control circuit 320, which is mounted on the circuit board 301. The first control circuit 310 controls the feed motor 100. The second control circuit 320 controls the twisting motor 200.

The circuit board 301 has an elongated plate shape that is elongated in a prescribed direction. The circuit board 301 has a first surface 301A and a second surface 301B, which faces towards the opposite direction of the first surface 301A. In the present embodiment, the first control circuit 310 and the second control circuit 320 are each mounted on the first surface 301A of the circuit board 301.

The first control circuit 310 comprises a microcomputer 311, a gate-driver circuit 312, an inverter circuit 313, and a capacitor 314. The microcomputer 311 comprises: a processor, such as a CPU (central-processing unit); nonvolatile memory, such as ROM (read-only memory); and volatile memory, such as RAM (random-access memory). The inverter circuit 313 supplies the coils 205 with drive currents based on the electric power supplied from the battery 10. The inverter circuit 313 comprises six switching elements. Each of the switching elements comprises a field-effect transistor (FET). It is noted that the switching elements may be IGBTs or may be MOSFETs. The gate-driver circuit 312 is a drive circuit for driving the switching elements of the inverter circuit 313. The microcomputer 311 outputs control signals to the gate-driver circuit 312 and drives the switching elements of the inverter circuit 313. The capacitor 314 is provided to reduce the noise when switching is performed by the switching elements. In addition, the capacitor 314 is provided to reduce inductance when the battery 10 is mounted on the foot part 8.

The second control circuit 320 comprises a microcomputer 321, a gate-driver circuit 322, an inverter circuit 323, and a capacitor 324. The structure and functions of the microcomputer 321 are substantially the same as the structure and functions of the microcomputer 311. The structure and functions of the gate-driver circuit 322 are substantially the same as the structure and functions of the gate-driver circuit 312. The structure and functions of the inverter circuit 323 are substantially the same as the structure and functions of the inverter circuit 313. The structure and functions of the capacitor 324 are substantially the same as the structure and functions of the capacitor 314. Explanations concerning the microcomputer 321, the gate-driver circuit 322, the inverter circuit 323, and the capacitor 324 are omitted.

### Arrangement of the Controller

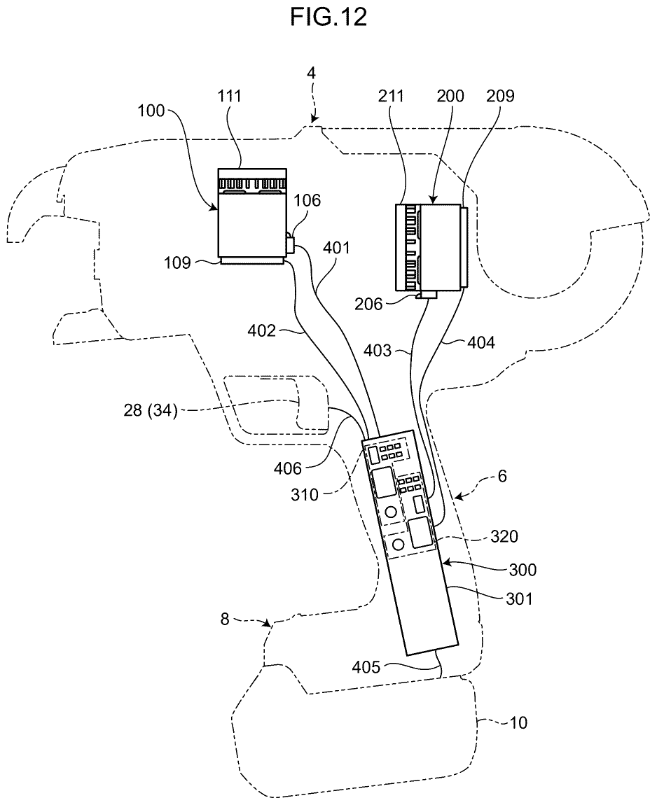

FIG. 12 is a diagram schematically showing a layout example of the controller 300 according to the present embodiment. The controller 300 is disposed in the grip part 6. More specifically, the controller 300 is disposed in the grip part 6 so that the circuit board 301 extends in the up-down direction. The controller 300 is disposed in the grip part 6 so that the first surface 301A of the circuit board 301, on which the first control circuit 310 and the second control circuit 320 are mounted, faces leftward. It is noted that the controller 300 may instead be disposed in the grip part 6 so that the first surface 301A of the circuit board 301 faces rightward.

The feed motor 100 and the twisting motor 200 are disposed more upward than the controller 300. The feed motor 100 and the twisting motor 200 are disposed in the head part 4. In the head part 4, the feed motor 100 is disposed more forward than the twisting motor 200.

The feed motor 100 is disposed so that the rotational axis of the rotor 102 and the rotor shaft 103 extends in the up-down direction. The fan 111 is disposed more upward than the stator 101. The terminals 106, which respectively connect pairs of the coils of the stator 101, are disposed at a rear portion of the stator 101. The sensor board 109, which detects the rotation of the rotor 102, is disposed more downward than the stator 101. The terminals 106 and the controller 300 are connected by power cables 401. As described above, three of the terminals 106 are provided. One of the terminals 106 and the controller 300 are connected by one of the power cables 401. Three of the power cables 401 are provided. Five signal cables 402 are provided.

The twisting motor 200 is disposed so that the rotational axis of the rotor 202 and the rotor shaft 203 extends in the front-rear direction. The fan 211 is disposed more forward than the stator 201. The terminals 206, which respectively connect pairs of the coils of the stator 201, are disposed at a lower portion of the stator 201. The sensor board 209, which detects the rotation of the rotor 202, is disposed more rearward than the stator 201. The terminals 206 and the controller 300 are connected by power cables 403. As described above, three of the terminals 206 are provided. One of the terminals 206 and the controller 300 are connected by one of the power cables 403. Three of the power cables 403 are provided. Five signal cables 404 are provided.

The controller 300 and the battery terminals of the battery 10 are electrically connected by power-supplying cables 405. Two of the power-supplying cables 405 are provided. Electric power is output from the battery 10 to the controller 300 via the power-supplying cables 405.

The controller 300 and the trigger 28 (the trigger switch 34) are electrically connected by a signal cable 406. One signal cable 406 is provided. The manipulation signal, which is generated in the trigger switch 34 (see FIG. 4) when the trigger 28 is manipulated, is transmitted from the trigger switch 34 to the controller 300 via the signal cable 406.

The first control circuit 310 supplies the terminals 106 with electric power from the battery 10 via the power cables 401. The electric power supplied to the terminals 106 is supplied to the coils 105 of the feed motor 100. The rotor 102 of the feed motor 100 rotates owing to the electric power being supplied to the coils 105 of the feed motor 100. The detection signal of the sensor board 109, which detects rotation of the rotor 102, is input into the first control circuit 310 via the signal cables 402. The first control circuit 310 controls the electric power supplied to the coils 105 of the feed motor 100 based on the detection signal from the sensor board 109.

The second control circuit 320 supplies the terminals 206 with electric power from the battery 10 via the power cables 403. The electric power supplied to the terminals 206 is supplied to the coils 205 of the twisting motor 200. The rotor 202 of the twisting motor 200 rotates owing to the electric power being supplied to the coils 205 of the twisting motor 200. The detection signal of the sensor board 209, which detects rotation of the rotor 202, is input into the second control circuit 320 via the signal cables 404. The second control circuit 320 controls the electric power supplied to the coils 205 of the twisting motor 200 based on the detection signal from the sensor board 209.

### Effects

As described above, in the first embodiment, the rebar-tying tool 2 comprises: the feed motor 100, which is the first brushless motor that feeds the wire wound around the reel 24; the twisting motor 200, which is the second brushless motor that twists the wire that is fed by the feed motor 100; the head part 4, in which the reel 24, the feed motor 100, and the twisting motor 200 are disposed; the grip part 6, which extends downward from the head part 4; the foot part 8, which is disposed downward of the grip part 6 and to which the battery 10 is connectable; and the controller 300, which controls the feed motor 100 and the twisting motor 200. The controller 300 is disposed in the grip part 6.

In the above-mentioned configuration, the controller 300 is disposed in a suitable location in the rebar-tying tool 2.

### Second Embodiment

A second embodiment will be described. In the explanation below, structural elements that are identical or equivalent to those in the embodiment described above are assigned the same reference numerals, and descriptions of those structural elements are simplified or omitted.

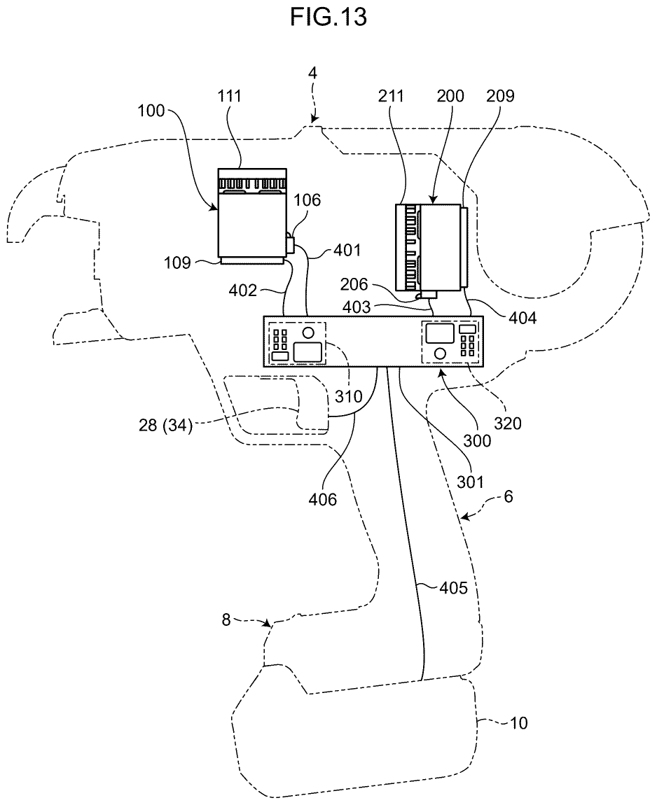

FIG. 13 is a diagram schematically showing a layout example of the controller 300 according to the present embodiment. In the example shown in FIG. 13, the controller 300 is disposed in the head part 4. In the head part 4, the controller 300 is disposed more downward than the feed motor 100 and the twisting motor 200. The controller 300 is disposed in the head part 4 so that the circuit board 301 extends in the front-rear direction. The controller 300 is disposed in the head part 4 so that the first surface 301A of the circuit board 301, on which the first control circuit 310 and the second control circuit 320 are mounted, faces leftward. It is noted that the controller 300 may instead be disposed in the head part 4 so that the first surface 301A of the circuit board 301 faces rightward.

The first control circuit 310, which comprises the gate-driver circuit 312 and the inverter circuit 313 for controlling the feed motor 100, is mounted on the forward side of the circuit board 301. The second control circuit 320, which comprises the gate-driver circuit 322 and the inverter circuit 323 for controlling the twisting motor 200, is mounted on the rearward side of the circuit board 301.

As explained above, in an embodiment in which the twisting motor 200 is disposed more rearward than the feed motor 100, the first control circuit 310, which is for controlling the feed motor 100, is mounted on the forward side of the circuit board 301, and the second control circuit 320, which is for controlling the twisting motor 200, is mounted on the rearward side of the circuit board 301. Thereby, the lengths of the power cables 401, the signal cables 402, the power cables 403, and the signal cables 404 can each be shortened.

### Third Embodiment

A third embodiment will be described. In the explanation below, structural elements that are identical or equivalent to those in the embodiments described above are assigned the same reference numerals, and descriptions of those structural elements are simplified or omitted.

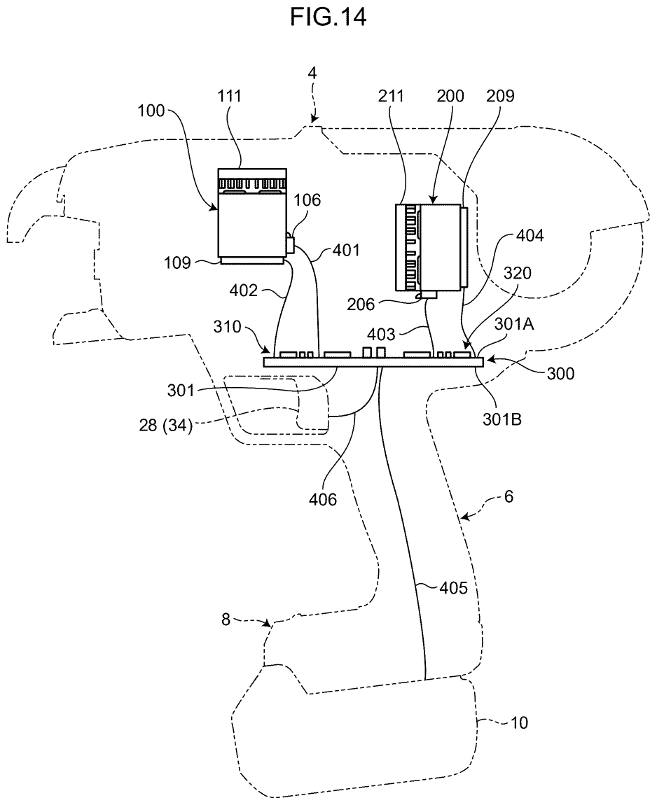

FIG. 14 is a diagram schematically showing a layout example of the controller 300 according to the present embodiment. In the example shown in FIG. 14, the controller 300 is disposed in the head part 4. In the head part 4, the controller 300 is disposed more downward than the feed motor 100 and the twisting motor 200. The controller 300 is disposed in the head part 4 so that the circuit board 301 extends in the front-rear direction. The controller 300 is disposed in the head part 4 so that the first surface 301A of the circuit board 301, on which the first control circuit 310 and the second control circuit 320 are mounted, faces upward. It is noted that the controller 300 may instead be disposed in the head part 4 so that the first surface 301A of the circuit board 301 faces downward.

The first control circuit 310, which comprises the gate-driver circuit 312 and the inverter circuit 313 for controlling the feed motor 100, is mounted on the forward side of the circuit board 301. The second control circuit 320, which comprises the gate-driver circuit 322 and the inverter circuit 323 for controlling the twisting motor 200, is mounted on the rearward side of the circuit board 301.

As explained above, in an embodiment in which the twisting motor 200 is disposed more rearward than the feed motor 100, the first control circuit 310, which is for controlling the feed motor 100, is mounted on the forward side of the circuit board 301, and the second control circuit 320, which is for controlling the twisting motor 200, is mounted on the rearward side of the circuit board 301. Thereby, the lengths of the power cables 401, the signal cables 402, the power cables 403, and the signal cables 404 can each be shortened.

### Fourth Embodiment

A fourth embodiment will be described. In the explanation below, structural elements that are identical or equivalent to those in the embodiments described above are assigned the same reference numerals, and descriptions of those structural elements are simplified or omitted.

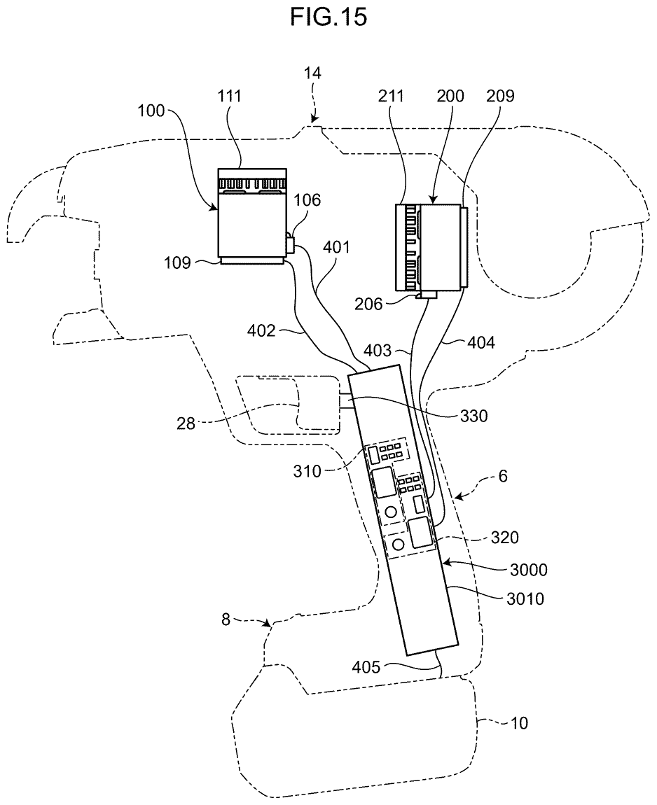

FIG. 15 is a diagram schematically showing a layout example of a controller 3000 according to the present embodiment. In the example shown in FIG. 15, the controller 3000 is disposed in the grip part 6. A circuit board 3010 of the controller 3000 comprises a holding part 330, which holds the trigger 28. The trigger 28 is held directly by the circuit board 3010 of the controller 3000 via the holding part 330. The controller 3000 is an integrated controller that is integrated with the trigger 28. In the embodiment, the signal cable 406 is omitted.

### Fifth Embodiment

A fifth embodiment will be described. In the explanation below, structural elements that are identical or equivalent to those in the embodiments described above are assigned the same reference numerals, and descriptions of those structural elements are simplified or omitted.

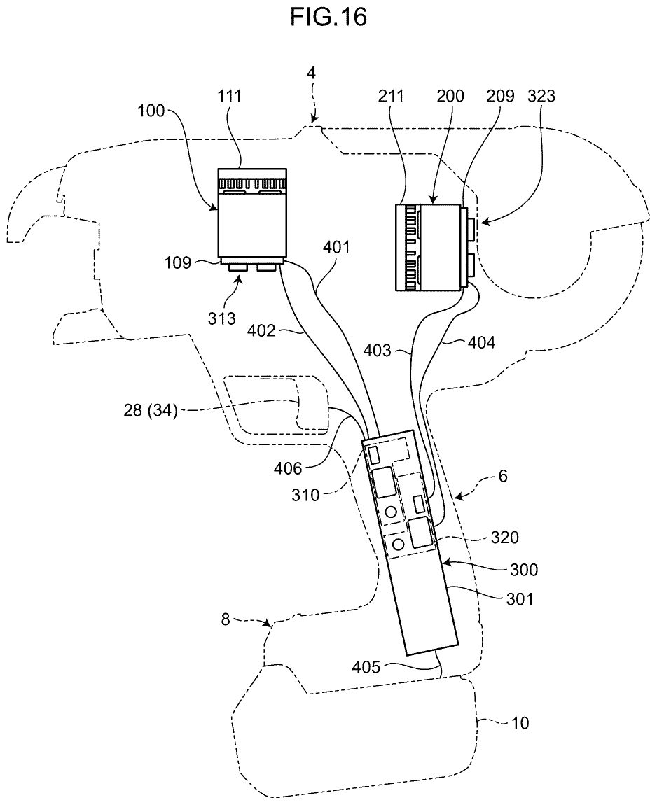

FIG. 16 is a diagram schematically showing a layout example of the controller 300 according to the present embodiment. In the fifth embodiment, at least one of the feed motor 100 (first brushless motor) and the twisting motor 200 (second brushless motor) comprises a sensor board for detecting the rotation of the rotor, and the sensor board comprises an inverter circuit for driving the motor. FIG. 16 shows an example in which inverter circuits 313, 323 are provided on the sensor board 109 of the feed motor 100 and on the sensor board 209 of the twisting motor 200, respectively.

In the example shown in FIG. 16, the controller 300 is disposed in the grip part 6. The controller 300 is electrically connected to the sensor board 109 of the feed motor 100 by both the power cables 401 and the signal cables 402. The controller 300 is electrically connected to the stator 101 of the feed motor 100 via the sensor board 109. The controller 300 is electrically connected to the sensor board 209 of the twisting motor 200 by both the power cables 403 and the signal cables 404. The controller 300 is electrically connected to the stator 201 of the twisting motor 200 via the sensor board 209.

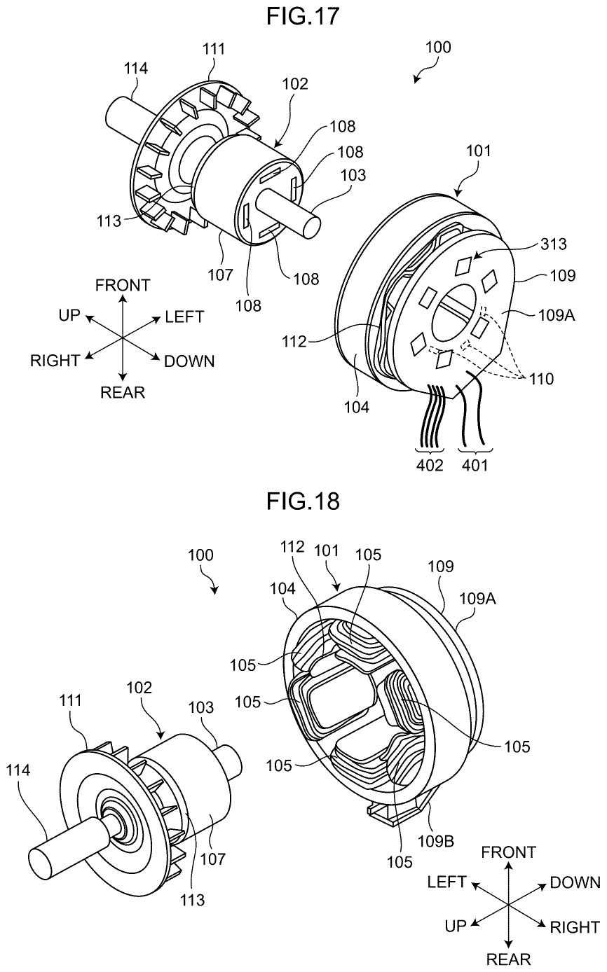

FIG. 17 is an exploded, oblique view, viewed from the front right and below, of the feed motor 100 according to the present embodiment. FIG. 18 is an exploded, oblique view, viewed from the front right and above, of the feed motor 100 according to the present embodiment.

The sensor board 109 is mounted on the stator 101. The inverter circuit 313, in addition to the magnetic sensors 110, is provided on the circuit-board part 109A of the sensor board 109. The inverter circuit 313 is provided on a downward surface of the sensor board 109. The inverter circuit 313 comprises six switching elements, which control the supply of electric current to each of the U-phase coils, the V-phase coils, and the W-phase coils. The inverter circuit 313 is electrically connected to the controller 300 (the gate-driver circuit 312) via the power cables 401 and the signal cables 402, which are electrically connected to the sensor board 109. The inverter circuit 313 is electrically connected from the sensor board 109 to each of the coils 105 (U-phase coils, V-phase coils, and W-phase coils) of the stator 101 by wiring (not shown). Consequently, in the examples shown in FIG. 17 and FIG. 18, the terminals 106 (see FIG. 7), which are for supplying electrical power to each of the coils 105, are not provided.

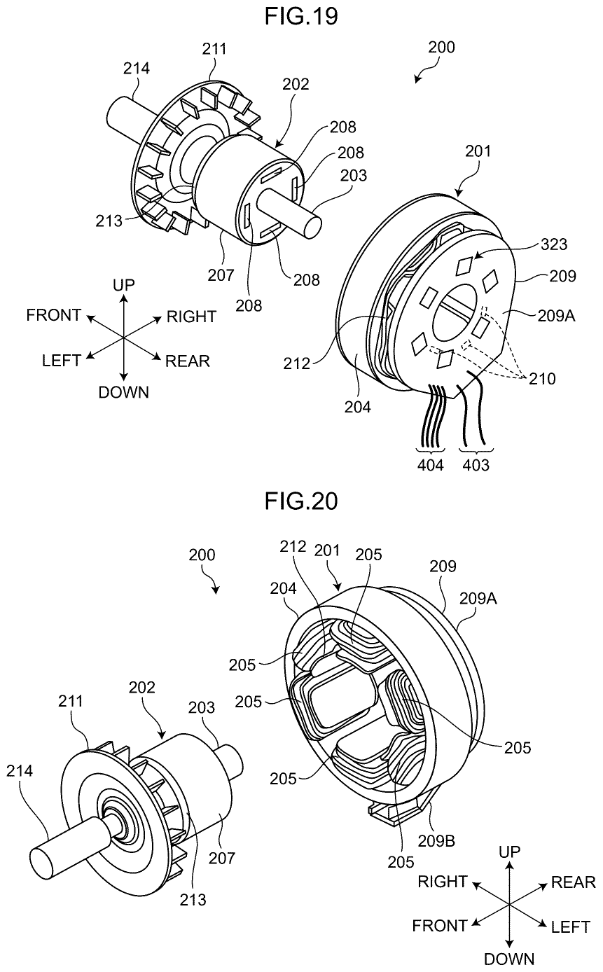

FIG. 19 is an exploded, oblique view, viewed from the upper left and the rear, of the twisting motor 200 according to the present embodiment. FIG. 20 is an exploded, oblique view, viewed from the upper left and the front, of the twisting motor 200 according to the present embodiment.

The sensor board 209 is mounted on the stator 201. The inverter circuit 323, in addition to the magnetic sensors 210, is provided on the circuit-board part 209A of the sensor board 209. The inverter circuit 323 is provided on a rearward surface of the sensor board 209. The inverter circuit 323 comprises six switching elements, which control the supply of electric current to each of the U-phase coils, the V-phase coils, and the W-phase coils. The inverter circuit 323 is electrically connected to the controller 300 (the gate-driver circuit 322) via the power cables 403 and the signal cables 404, which are electrically connected to the sensor board 209. The inverter circuit 323 is electrically connected from the sensor board 209 to each of the coils 205 (U-phase coils, V-phase coils, and W-phase coils) of the stator 201 by wiring (not shown). Consequently, in the examples shown in FIG. 19 and FIG. 20, the terminals 206 (see FIG. 7), which are for supplying electrical power to each of the coils 205, are not provided.

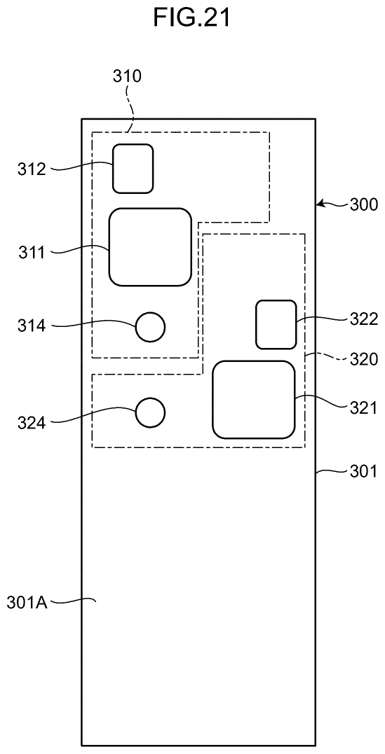

FIG. 21 is a front view that shows the controller 300 according to the present embodiment. The controller 300 comprises: the first control circuit 310, which controls the feed motor 100; and the second control circuit 320, which controls the twisting motor 200. The first control circuit 310 and the second control circuit 320 are each mounted on the first surface 301A of the circuit board 301.

The first control circuit 310 comprises the microcomputer 311, the gate-driver circuit 312, and the capacitor 314. In the present embodiment, the controller 300 (the first control circuit 310) is not provided with the inverter circuit 313 because the inverter circuit 313 is provided on the sensor board 109. The gate-driver circuit 312 drives the inverter circuit 313 of the sensor board 109 via the signal cables 402.

The second control circuit 320 comprises the microcomputer 321, the gate-driver circuit 322, and the capacitor 324. In the present embodiment, the controller 300 (the second control circuit 320) is not provided with the inverter circuit 323 because the inverter circuit 323 is provided on the sensor board 209. The gate-driver circuit 322 drives the inverter circuit 323 of the sensor board 209 via the signal cables 404.

It is noted that, in the fifth embodiment, although the inverter circuit 313 and the inverter circuit 323 for driving the motor are provided on the sensor board 109 of the feed motor 100 (the first brushless motor) and on the sensor board 209 of the twisting motor 200 (the second brushless motor), respectively, the inverter circuits may be provided on only one of the sensor boards. In addition, one portion of the inverter circuits may be provided on the controller 300.

As explained above, the controller 300 is disposed in the grip part 6. Thereby, the controller 300 is disposed at a suitable location in the rebar-tying tool 2.

In the fifth embodiment, the feed motor 100, which is the first brushless motor, comprises the sensor board 109, which is the first sensor board for detecting the rotation of the rotor 102. The sensor board 109 comprises the inverter circuit 313 for driving the motor. Thereby, the connections for the power cables 401, which supply drive current to the feed motor 100, and the signal cables 402, which transmit signals to the feed motor 100, can be aggregated on the sensor board 109. Terminals for electrically connecting the power cables 401 to the feed motor 100 do not need to be provided. Because constraints on the arrangement that accompany the wiring process no longer tend to have an impact, the degrees of freedom in the arrangement of the controller 300 increase.

In the fifth embodiment, the twisting motor 200, which is the second brushless motor, comprises the sensor board 209, which is the second sensor board for detecting the rotation of the rotor 202. The sensor board 209 comprises the inverter circuit 323 for driving the motor. Thereby, the connections for the power cables 403, which supply drive current to the twisting motor 200, and the signal cables 404, which transmit signals to the twisting motor 200, can be aggregated on the sensor board 209. Terminals for electrically connecting the power cables 403 to the twisting motor 200 do not need to be provided. Because constraints on the arrangement that accompany the wiring process no longer tend to have an impact, the degrees of freedom in the arrangement of the controller 300 increase.

### Sixth Embodiment

A sixth embodiment will be described. In the explanation below, structural elements that are identical or equivalent to those in the embodiments described above are assigned the same reference numerals, and descriptions of those structural elements are simplified or omitted.

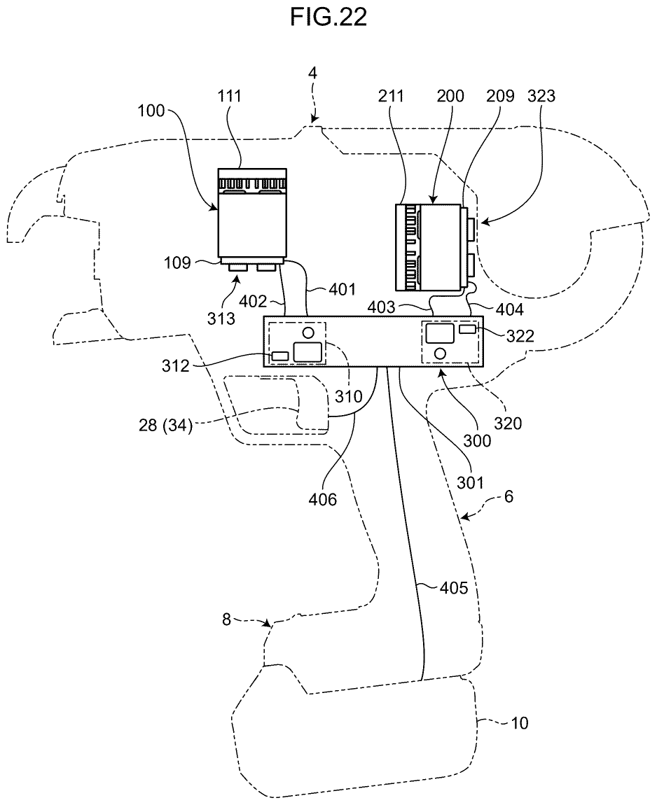

FIG. 22 is a diagram schematically showing a layout example of the controller 300 according to the present embodiment. In the example shown in FIG. 22, the controller 300 is disposed in the head part 4. In the head part 4, the controller 300 is disposed more downward than the feed motor 100 and the twisting motor 200. The controller 300 is disposed in the head part 4 so that the circuit board 301 extends in the front-rear direction. The controller 300 is disposed in the head part 4 so that the first surface 301A of the circuit board 301, on which the first control circuit 310 and the second control circuit 320 are mounted, faces leftward. It is noted that the controller 300 may instead be disposed in the head part 4 so that the first surface 301A of the circuit board 301 faces rightward.

The sensor board 109 is disposed more downward than the stator 101 of the feed motor 100. The first control circuit 310, which comprises the gate-driver circuit 312 for controlling the feed motor 100, is mounted on the forward side of the circuit board 301. The first control circuit 310 is disposed at a location on the circuit board 301 that is on the sensor board 109 side. The sensor board 109 is disposed upward of the first control circuit 310. The inverter circuit 313, which is for controlling the feed motor 100, is provided on the sensor board 109. Consequently, the inverter circuit 313 is not provided on the first control circuit 310.

The sensor board 209 is disposed more rearward than the stator 201 of the twisting motor 200. The second control circuit 320, which comprises the gate-driver circuit 322 for controlling the twisting motor 200, is mounted on the rearward side of the circuit board 301. The second control circuit 320 is disposed at a location on the circuit board 301 that is proximate to the sensor board 209. The sensor board 209 is disposed upward of the second control circuit 320. The inverter circuit 323, which is for controlling the twisting motor 200, is provided on the sensor board 209. Consequently, the inverter circuit 323 is not provided on the second control circuit 320.

The first surface 301A of the circuit board 301 and the sensor board 109 are connected by the power cables 401 and the signal cables 402. The sensor board 109 and the stator 101 are connected by wiring. The inverter circuit 313 is driven by the gate-driver circuit 312 to thereby supply electric power from the power cables 401 to each of the coils 105 (the U-phase coils, V-phase coils, and W-phase coils) of the feed motor 100 via the wiring of the sensor board 109. The first surface 301A of the circuit board 301 and the sensor board 209 are connected by the power cables 403 and the signal cables 404. The sensor board 209 and the stator 201 are connected by wiring. The inverter circuit 323 is driven by the gate-driver circuit 322 to thereby supply electric power from the power cables 403 to each of the coils 205 (the U-phase coils, V-phase coils, and W-phase coils) of the twisting motor 200 via the wiring of the sensor board 209.

As described above, the twisting motor 200 is disposed more rearward than the feed motor 100. The inverter circuit 313, which is for controlling the feed motor 100, is provided on the sensor board 109. The inverter circuit 323, which is for controlling the twisting motor 200, is provided on the sensor board 209. In addition, the first surface 301A of the circuit board 301 and the sensor board 109 of the feed motor 100 are connected by the power cables 401 and the signal cables 402. The first surface 301A of the circuit board 301 and the sensor board 209 of the twisting motor 200 are connected by the power cables 403 and the signal cables 404. In addition, the first control circuit 310, which is for controlling the feed motor 100, is mounted at a forward-side location on the circuit board 301. The second control circuit 320, which is for controlling the twisting motor 200, is mounted at a rearward-side location on the circuit board 301. Thereby, the lengths of the power cables 401, the signal cables 402, the power cables 403, and the signal cables 404 can each be shortened.

### Seventh Embodiment

A seventh embodiment will be described. In the explanation below, structural elements that are identical or equivalent to those in the embodiments described above are assigned the same reference numerals, and descriptions of those structural elements are simplified or omitted.

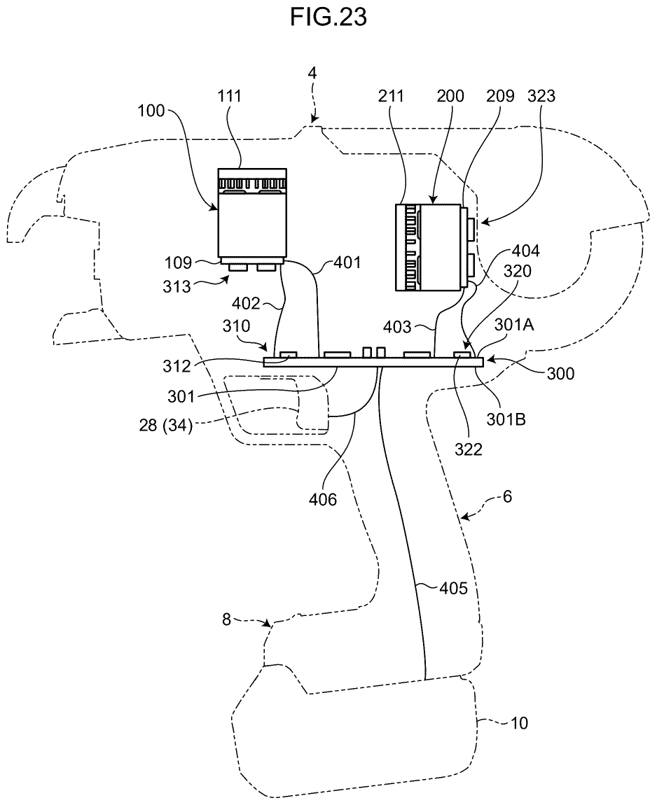

FIG. 23 is a diagram schematically showing a layout example of the controller 300 according to the present embodiment. In the example shown in FIG. 23, the controller 300 is disposed in the head part 4. In the head part 4, the controller 300 is disposed more downward than the feed motor 100 and the twisting motor 200. The controller 300 is disposed in the head part 4 so that the circuit board 301 extends in the front-rear direction. The controller 300 is disposed in the head part 4 so that the first surface 301A of the circuit board 301, on which the first control circuit 310 and the second control circuit 320 are mounted, faces upward. It is noted that the controller 300 may instead be disposed in the head part 4 so that the first surface 301A of the circuit board 301 faces downward.

The sensor board 109 is disposed more downward than the stator 101 of the feed motor 100. The first control circuit 310, which comprises the gate-driver circuit 312 for controlling the feed motor 100, is mounted on the forward side of the circuit board 301. The first control circuit 310 is disposed at a location more proximate to the sensor board 109 than to the second control circuit 320. The sensor board 109 is disposed upward of the first control circuit 310, and the sensor board 109 and the first control circuit 310 are lined up vertically. The inverter circuit 313, which is for controlling the feed motor 100, is provided on the sensor board 109. Consequently, the inverter circuit 313 is not provided on the first control circuit 310.

The sensor board 209 is disposed more rearward than the stator 201 of the twisting motor 200. The second control circuit 320, which comprises the gate-driver circuit 322 for controlling the twisting motor 200, is mounted on the rearward side of the circuit board 301. The second control circuit 320 is disposed at a location more proximate to the sensor board 209 than to the first control circuit 310. The sensor board 209 is disposed upward of the second control circuit 320, and the sensor board 209 and the second control circuit 320 are lined up vertically. The inverter circuit 323, which is for controlling the twisting motor 200, is provided on the sensor board 209. Consequently, the inverter circuit 323 is not provided on the second control circuit 320.

The first surface 301A of the circuit board 301 and the sensor board 109 are electrically connected by the power cables 401 and the signal cables 402. The first surface 301A of the circuit board 301 and the sensor board 209 are electrically connected by the power cables 403 and the signal cables 404.

As described above, the twisting motor 200 is disposed more rearward than the feed motor 100. In addition, the inverter circuit 313, which is for controlling the feed motor 100, is provided on the sensor board 109. The inverter circuit 323, which is for controlling the twisting motor 200, is provided on the sensor board 209. In addition, the first surface 301A of the circuit board 301 and the sensor board 109 are electrically connected by the power cables 401 and the signal cables 402. The first surface 301A of the circuit board 301 and the sensor board 209 are electrically connected by the power cables 403 and the signal cables 404. In addition, the first control circuit 310, which is for controlling the feed motor 100, is mounted at a location more proximate to the sensor board 109 than to the second control circuit 320. The second control circuit 320, which is for controlling the twisting motor 200, is mounted at a location more proximate to the sensor board 209 than to the first control circuit 310. Thereby, the lengths of the power cables 401, the signal cables 402, the power cables 403, and the signal cables 404 can each be shortened.

### Eighth Embodiment

An eighth embodiment will be described. In the explanation below, structural elements that are identical or equivalent to those in the embodiments described above are assigned the same reference numerals, and descriptions of those structural elements are simplified or omitted.

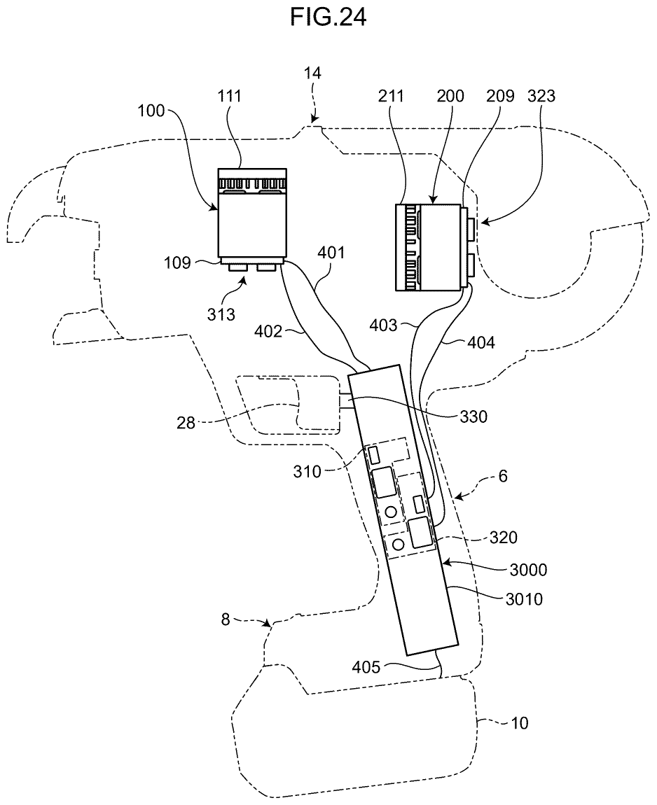

FIG. 24 is a diagram schematically showing a layout example of the controller 3000 according to the present embodiment. In the example shown in FIG. 24, the controller 3000 is disposed in the grip part 6. The circuit board 3010 of the controller 3000 comprises the holding part 330, which holds the trigger 28. The trigger 28 is held directly by the circuit board 3010 of the controller 3000 via the holding part 330. The controller is an integrated controller that is integrated with the trigger 28. In the embodiment, the signal cable 406 is omitted.

The sensor board 109 is disposed on the feed motor 100. The inverter circuit 313, which is for controlling the feed motor 100, is provided on the sensor board 109. Consequently, the inverter circuit 313 is not provided on the first control circuit 310. The sensor board 209 is disposed on the twisting motor 200. The inverter circuit 323, which is for controlling the twisting motor 200, is provided on the sensor board 209. Consequently, the inverter circuit 323 is not provided on the second control circuit 320.

The circuit board 3010 and the sensor board 109 are electrically connected by the power cables 401 and the signal cables 402. The controller 3000 performs drive control of the feed motor 100 via the sensor board 109. The circuit board 3010 and the sensor board 209 are connected by the power cables 403 and the signal cables 404. The controller 3000 performs drive control of the twisting motor 200 via the sensor board 209.

As described above, the inverter circuit 313, which is for controlling the feed motor 100, is provided on the sensor board 109. The inverter circuit 323, which is for controlling the twisting motor 200, is provided on the sensor board 209. Thereby, by providing the inverter circuits 313, 323 on the sensor boards 109, 209, which each detect the rotation of the corresponding rotor, the inverter circuits 313, 323 can be omitted from the circuit board 3010 of the controller 3000. Because constraints on the arrangement that accompany the wiring process no longer tend to have an impact, the degrees of freedom in the arrangement of the controller 300 increase.

### Ninth Embodiment

A ninth embodiment will be described. In the explanation below, structural elements that are identical or equivalent to those in the embodiments described above are assigned the same reference numerals, and descriptions of those structural elements are simplified or omitted.

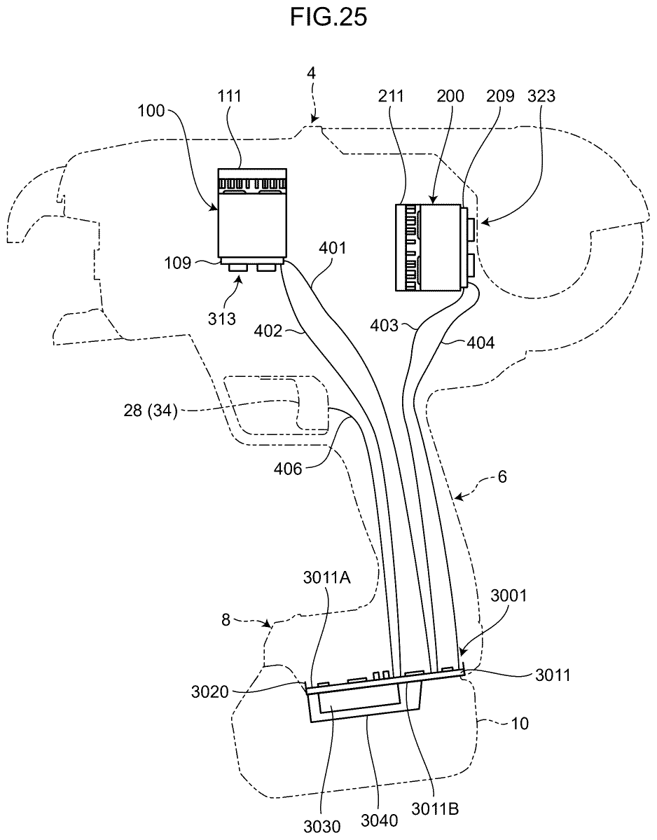

FIG. 25 is a diagram schematically showing a layout example of a controller 3001 according to the present embodiment. The controller 3001 is disposed in the foot part 8. The controller 3001 is disposed in the foot part 8 so that a circuit board 3011 extends in the front-rear direction. The controller 3001 is disposed in the foot part 8 so that a first surface 3011A of the circuit board 3011, on which the first control circuit 310 and the second control circuit 320 are mounted, faces upward.

The sensor board 109 is disposed on the feed motor 100. The inverter circuit 313, which is for controlling the feed motor 100, is provided on the sensor board 109. Consequently, the inverter circuit 313 is not provided on the first control circuit 310. The sensor board 209 is disposed on the twisting motor 200. The inverter circuit 323, which is for controlling the twisting motor 200, is provided on the sensor board 209. Consequently, the inverter circuit 323 is not provided on the second control circuit 320.

The circuit board 3011 and the sensor board 109 are connected by the power cables 401 and the signal cables 402. The controller 3001 performs drive control of the feed motor 100 via the sensor board 109. The circuit board 3011 and the sensor board 209 are electrically connected by the power cables 403 and the signal cables 404. The controller 3001 performs drive control of the twisting motor 200 via the sensor board 209.

In the ninth embodiment, the controller 3001 comprises: the circuit board 3011; a controller case 3020, which houses the circuit board 3011; and terminals 3030, which connect the battery 10 and the circuit board 3011. In the ninth embodiment, the controller 3001 (the circuit board 3011) is directly connected to the battery 10 by the terminals 3030. Consequently, in the present embodiment, the power-supplying cables 405 are omitted.

The controller case 3020 is a flat, dish shape or tray shape in which the upper surface is recessed in a concave shape. The controller case 3020 houses the circuit board 3011 in the interior of the recessed portion. The controller case 3020 is housed inside the housing 12, which constitutes the foot part 8. A lower surface of the controller case 3020 constitutes one portion of a connection surface with the battery 10 in the foot part 8. The terminals 3030, which are for connecting to the battery 10, are provided on a second surface 3011B of the circuit board 3011. The lower surface of the controller case 3020 causes one portion of each of the terminals 3030 to be exposed so that the terminals 3030 are connectable to the terminals of the battery 10. A guide 3040 may be formed on the lower surface of the controller case 3020. The guide 3040 partially covers the terminals 3030 and protects the terminals from the exterior and also guides the battery 10 when connecting the terminals of the battery to the terminals 3030. The lower surface of the controller case 3020, the terminals 3030, and the guide 3040 are covered by the housing of the battery 10 and are not exposed to the exterior in the state in which the battery 10 is connected.

As described above, in the ninth embodiment, the rebar-tying tool 2 comprises: the feed motor 100, which is the first brushless motor that feeds a wire that is wound around the reel 24; the twisting motor 200, which is the second brushless motor that twists the wire; the head part 4, in which the reel 24, the feed motor 100, and the twisting motor 200 are disposed; the grip part 6, which extends downward from the head part 4; the foot part 8, which is disposed downward of the grip part 6 and to which the battery 10 is connectable; and the controller 3001, which controls the feed motor 100 and the twisting motor 200; wherein: the controller 3001 is disposed in the foot part 8; and the controller 3001 comprises the circuit board 3011, the controller case 3020, which houses the circuit board 3011, and the terminals 3030, which connect the battery 10 and the circuit board 3011 to each other.

In the above-mentioned configuration, the controller 3001 is disposed at a suitable location in the rebar-tying tool 2. The power-supplying cables 405 can be omitted and the internal structure of the device can be simplified.

### Tenth Embodiment

A tenth embodiment will be described. In the explanation below, structural elements that are identical or equivalent to those in the embodiments described above are assigned the same reference numerals, and descriptions of those structural elements are simplified or omitted.

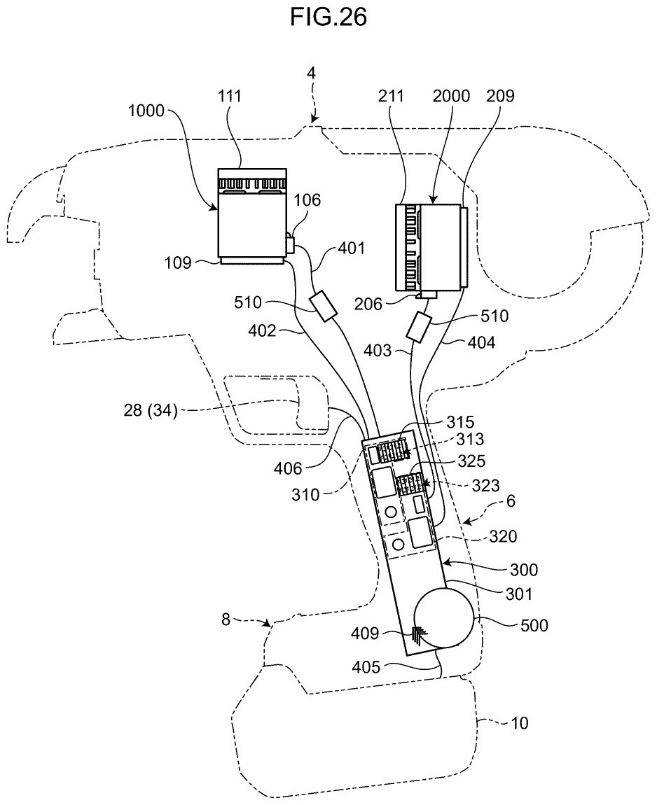

FIG. 26 is a diagram schematically showing a layout example of the controller 300 according to the present embodiment. As compared to the configuration shown in the first embodiment described above, a wireless-communication unit 500, heat sinks (315, 325), and noise-removing members (noise attenuating devices) 510 are further provided in the tenth embodiment.

The wireless-communication unit 500 is disposed in the grip part 6. The wireless-communication unit 500 is disposed in the grip part 6 so as to overlap the circuit board 301 of the controller 300 in the left-right direction. The wireless-communication unit 500 is disposed in the grip part 6 leftward of the circuit board 301. The wireless-communication unit 500 is disposed between the circuit board 301 and the left housing 14. The wireless-communication unit 500 may be disposed in the grip part 6 rightward of the circuit board 301. The wireless-communication unit 500 may be disposed, for example, between the circuit board 301 and the right housing 16.

The wireless-communication unit 500 may be detachable from the housing 12. A mounting opening for mounting the wireless-communication unit 500 may be formed, for example, in the outer surface of the left housing 14 (or the outer surface of the right housing 16), and the wireless-communication unit 500 may be configured to be mounted in the mounting opening from the exterior of the housing 12. Thus, in this configuration, an electrical connection with the controller 300 is established by mounting the wireless-communication unit 500 in the mounting opening. In addition, the wireless-communication unit 500 may be provided in (on) the head part 4, the foot part 8, or the battery 10.

In FIG. 26, the wireless-communication unit 500 can be electrically connected to the controller 300 by a wired connection or can be mounted directly on the circuit board 301. The controller 300 supplies electric power from the battery 10 to the wireless-communication unit 500. The controller 300 communicates with external equipment via the wireless-communication unit 500.

The wireless-communication unit 500 comprises an interface circuit for performing wireless communication. The wireless communication scheme is not particularly limited. The wireless-communication unit 500 communicates via, for example: near-field communication, such as Bluetooth®; WLAN communication, such as Wi-Fi®; microwaves; infrared rays (optical signals); a mobile-communication system, such as so-called 5G; or the like. The wireless-communication unit 500 is capable of communicating with another communications terminal—for example: a computer; a mobile device; a cloud server; a power tool, such as another rebar-tying tool; an external battery unit; or the like—via wireless communication. As one example, the wireless-communication unit 500 communicates with a terminal (such as a tablet-type terminal or a PC) that is for managing a power tool or power tools possessed by the user, including the rebar-tying tool 2.

The controller 300 can transmit information concerning the rebar-tying tool 2 via the wireless-communication unit 500. The information concerning the rebar-tying tool 2 can include, for example, information such as remaining charge, voltage value, electric-current value, etc., of the battery 10. The information concerning the rebar-tying tool 2 can include, for example, information or log data concerning the motors in the rebar-tying tool 2. The information concerning the motors can include motor rotational speed, torque, rotational direction, etc. The information concerning the rebar-tying tool 2 can include the present settings (action mode, etc.) of the rebar-tying tool 2. The information concerning the rebar-tying tool 2 can include, for example, cumulative value of the rebar tying count or the remaining amount of wire wound on the reel 24 (remaining tying count). In such an embodiment, the controller 300 may tally the rebar tying count based on drive information of a feed motor 1000 and compute the remaining tying count by subtracting a count value from an initial value of the tying count set in the reel 24. The controller 300 may periodically transmit this information concerning the rebar-tying tool 2 to a set transmission destination and may transmit the information concerning the rebar-tying tool 2 as a response signal in response to a request from the transmission destination. The controller 300 can receive a control signal via the wireless-communication unit 500. The control signal can include information that directs switching the power supply of the rebar-tying tool 2 ON or OFF or information that directs changing the action mode of the rebar-tying tool 2. The controller 300 controls the components of the rebar-tying tool 2 in accordance with the control signal received.

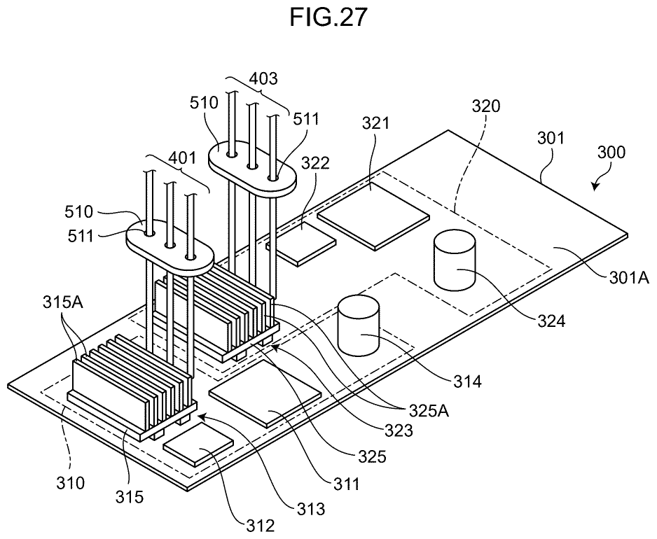

FIG. 27 is an oblique schematic view showing the controller 300 according to the present embodiment. The controller 300 comprises the circuit board 301, which comprises the inverter circuits (313, 323) for motor driving, and the heat sinks (315, 325), which are thermally connected to the inverter circuits. That is, the circuit board 301 comprises the heat sink 315, which is thermally connected to the inverter circuit 313 of the first control circuit 310. The heat sink 315 contacts the inverter circuit 313 via a thermally conductive material on surfaces of the switching elements that constitute the inverter circuit 313. The thermally conductive material is a thermally conductive grease, a thermally conductive bonding agent, or the like, and fills the gap between the surface of the heat sink 315 and the surfaces of the switching elements. The heat sink 315 comprises: a main-body part, which has a heat-transfer surface that contacts an object whose heat is to be absorbed, such as each switching element; and a plurality of fins 315A, which rise up from the main-body part. The fins 315A have a shape, such as a plate shape, a pin shape, or a lattice shape, and increase the heat-dissipating surface area of the heat sink 315. The heat sink 315 is composed of a highly thermally conductive material, such as an aluminum material (aluminum or an aluminum alloy). One heat sink 315 may be provided for one switching element, or one heat sink 315 may be provided for a plurality of the switching elements. The inverter circuit 313 can include, for example, one or two power modules in which a plurality of the switching elements is packaged. In this situation, the heat sink 315 may be installed on each power module.

The circuit board 301 comprises the heat sink 325, which is thermally connected to the inverter circuit 323 of the second control circuit 320. The heat sink 325 contacts the inverter circuit 323 via a thermally conductive material on surfaces of the switching elements that constitute the inverter circuit 323. The thermally conductive material is a thermally conductive grease, a thermally conductive bonding agent, or the like, and fills the gap between the surface of the heat sink 325 and the surfaces of the switching elements. The heat sink 325 comprises: a main-body part, which has a heat-transfer surface that contacts an object whose heat is to be absorbed, such as each switching element; and a plurality of fins 325A, which rise up from the main-body part. The fins 325A have a shape, such as a plate shape, a pin shape, or a lattice shape, and increase the heat-dissipating surface area of the heat sink 325. The heat sink 325 is composed of a highly thermally conductive material, such as an aluminum material (aluminum or an aluminum alloy). One heat sink 325 may be provided for one switching element, or one heat sink 325 may be provided for a plurality of the switching elements. The inverter circuit 323 can include, for example, one or two power modules in which a plurality of the switching elements are packaged. In this situation, the heat sink 325 may be installed on each power module.

The rebar-tying tool 2 comprises the noise-removing members 510 that remove (attenuate) electromagnetic noise on electric-power lines that electrically connect at least one of the feed motor 1000 (first brushless motor) and a twisting motor 2000 (second brushless motor) with the controller 300. Each of the noise-removing members 510 is provided in common with a plurality of wirings. Each of the noise-removing members 510 is a plate-shaped member in which a plurality of through holes 511, through which the wirings respectively pass, is formed. That is, one wiring is inserted through each of the through holes 511. In FIG. 27, each of the noise-removing members 510 is an oval-shaped flat plate, and three of the through holes 511 are provided therein passing through in the thickness direction. In plan view, the three through holes 511 are aligned along a straight line in the longitudinal-axis direction of each of the noise-removing members 510. Each of the noise-removing members 510 is composed of a ferromagnetic body. Each of the noise-removing members 510 is, for example, a permanent magnet.

In FIG. 27, two of the noise-removing members 510 are provided. The first noise-removing member 510 is provided on the power cables 401, which supply electric power to the feed motor 1000. The three electric-power lines (U-phase, V-phase, and W-phase electric-power lines) that constitute the power cables 401 are inserted through the three through holes 511, respectively, of the first noise-removing member 510. The second noise-removing member 510 is provided on the power cables 403, which supply electric power to the twisting motor 2000. The three electric-power lines (U-phase, V-phase, and W-phase electric-power lines) that constitute the power cables 403 are inserted through the three through holes 511, respectively, of the second noise-removing member 510.

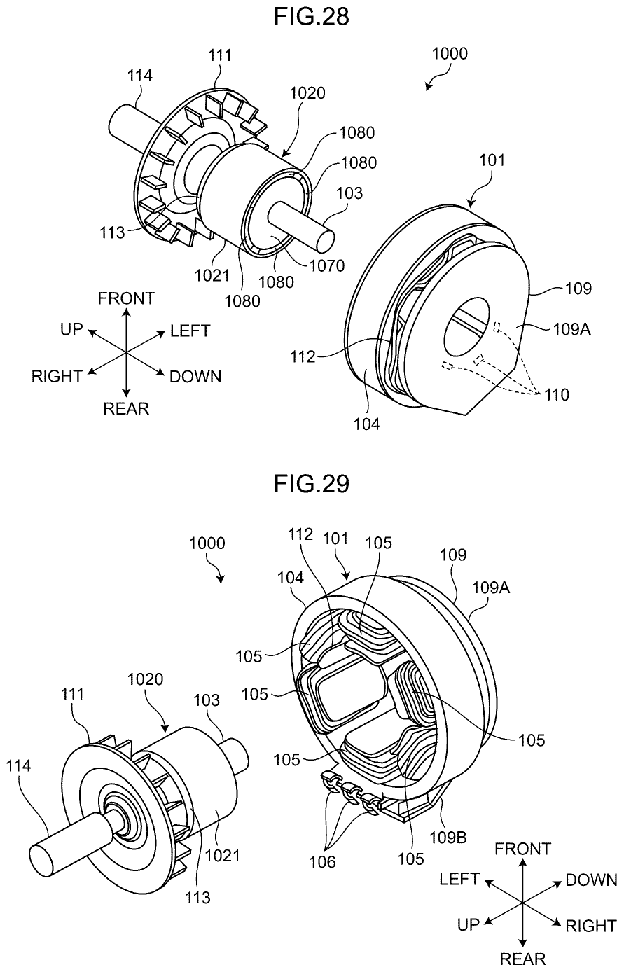

FIG. 28 is an exploded, oblique view, viewed from the front right and below, that shows the feed motor 1000 according to the present embodiment. FIG. 29 is an exploded, oblique view, viewed from the front right and above, that shows the feed motor 1000 according to the present embodiment. The above-mentioned first embodiment (see FIG. 6 and FIG. 7) described the feed motor 100, which is an IPM (interior permanent magnet) motor, in which the rotor magnets 108 are disposed in magnet holes provided in the rotor core 107; however, in the examples shown in FIG. 28 and FIG. 29, the feed motor 1000 is an SPM (surface permanent magnet) motor, in which rotor magnets 1080 are disposed on an outer circumferential surface of a rotor core 1070.

A rotor 1020 of the feed motor 1000 comprises the rotor core 1070, the rotor magnets 1080, and a retaining tube 1021. The rotor magnets 1080 are fixed to the rotor core 1070. The rotor magnets 1080 are disposed on the outer circumferential surface of the rotor core 1070. The rotor magnets 1080 are curved along the outer circumferential surface of the rotor core 1070. The rotor magnets 1080 are fixed to the outer circumferential surface of the rotor core 1070 by bonding, or the like. In the present embodiment, four of the rotor magnets 1080 are disposed in the circumferential direction of the rotor core 1070. The feed motor 1000 has a pole count of four. The number of rotor magnets 1080 is not particularly limited and may be a number other than four. The retaining tube 1021 has a circular-tube shape. The retaining tube 1021 encircles the outer circumferences of the rotor magnets 1080. An inner circumferential surface of the retaining tube 1021 presses the outer surfaces of the rotor magnets 1080 toward the rotor core 1070 (toward the center in the radial direction). The retaining tube 1021 prevents the rotor magnets 1080 from separating from the rotor core 1070. The retaining tube 1021 is composed of a steel material, a resin material, or the like.

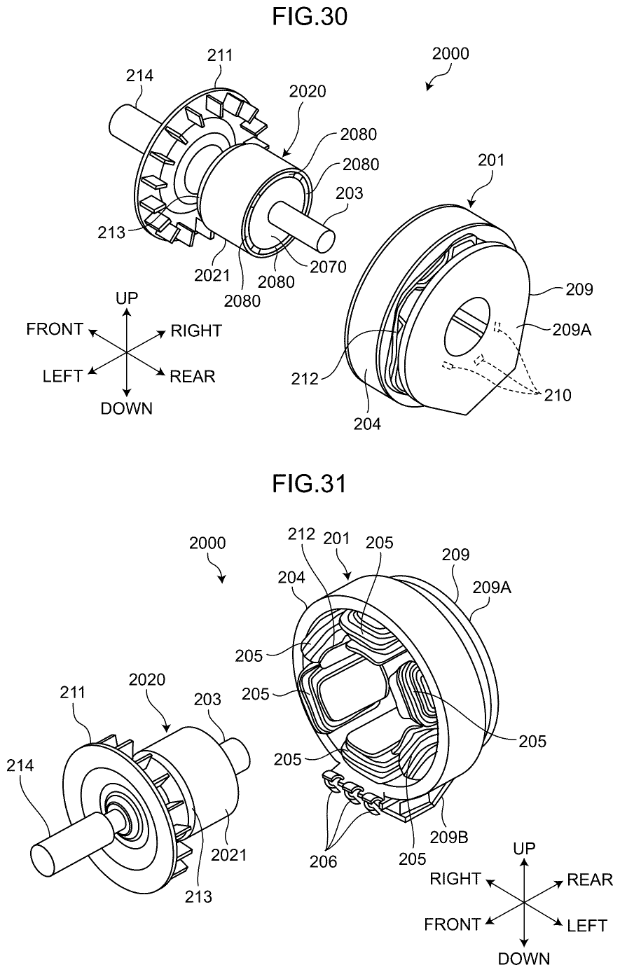

FIG. 30 is an exploded, oblique view, viewed from the upper left and the rear, of the twisting motor 2000 according to the present embodiment. FIG. 31 is an exploded, oblique view, viewed from the upper left and the front, of the twisting motor 2000 according to the present embodiment. The above-mentioned first embodiment (see FIG. 8 and FIG. 9) described the twisting motor 200, which is an IPM motor; however, in the examples shown in FIG. 30 and FIG. 31, the twisting motor 2000 is an SPM motor, in which rotor magnets 2080 are disposed on an outer circumferential surface of a rotor core 2070.

A rotor 2020 of the twisting motor 2000 comprises the rotor core 2070, the rotor magnets 2080, and a retaining tube 2021. The rotor magnets 2080 are fixed to the rotor core 2070. The rotor magnets 2080 are disposed on the outer circumferential surface of the rotor core 2070. The rotor magnets 2080 are curved along the outer circumferential surface of the rotor core 2070. The rotor magnets 2080 are fixed to the outer circumferential surface of the rotor core 2070 by bonding, or the like. In the present embodiment, four of the rotor magnets 2080 are disposed in the circumferential direction of the rotor core 2070. The twisting motor 2000 has a pole count of four. The number of rotor magnets 2080 is not particularly limited and may be a number other than four. The retaining tube 2021 has a circular-tube shape. The retaining tube 2021 encircles the outer circumferences of the rotor magnets 2080. An inner circumferential surface of the retaining tube 2021 presses the outer surfaces of the rotor magnets 2080 toward the rotor core 2070. The retaining tube 2021 prevents the rotor magnets 2080 from separating from the rotor core 2070. The retaining tube 2021 is composed of a steel material, a resin material, or the like.

Instead of the feed motor 100 and the twisting motor 200, the feed motor 1000 and the twisting motor 2000 in FIG. 28 through FIG. 31 may be provided in the second embodiment through the ninth embodiment described above.

As explained above, in the tenth embodiment, the controller 300 comprises the circuit board 301, which comprises: the inverter circuit 313 for motor driving of the feed motor 1000, which is the first brushless motor; and the heat sink 315, which is thermally connected to the inverter circuit 313.

In the above-mentioned configuration, temperature rises in the controller 300 can be curtailed.

In the tenth embodiment, the controller 300 comprises the circuit board 301, which comprises: the inverter circuit 323 for motor driving of the twisting motor 200, which is the second brushless motor; and the heat sink 325, which is thermally connected to the inverter circuit 323.

In the above-mentioned configuration, temperature rises in the controller 300 are curtailed.

In the tenth embodiment, the circuit board 301 comprises the heat sinks 315, 325, which are thermally connected to at least one of the inverter circuit 313, which is the first inverter circuit, and the inverter circuit 323, which is the second inverter circuit.

In the above-mentioned configuration, temperature rises in the controller 300 are curtailed.

In the tenth embodiment, the rebar-tying tool 2 further comprises the wireless-communication unit 500, which is provided in (on) the grip part 6.

In the above-mentioned configuration, the wireless-communication unit 500 and the controller 300 are disposed with a suitable positional relationship.

In the tenth embodiment, the rebar-tying tool 2 comprises the first noise-removing member 510, which removes electromagnetic noise on the electric-power lines of the power cables 401 that connect the feed motor 1000, which is the first brushless motor, and the controller 300 to each other. The rebar-tying tool 2 also comprises the second noise-removing member 510, which removes electromagnetic noise on the electric-power lines of the power cables 403 that connect the twisting motor 2000, which is the second brushless motor, and the controller 300 to each other.

In the above-mentioned configuration, in addition to disposing the brushless motors (the feed motor 1000 and the twisting motor 2000) and the controller 300 in a suitable positional relationship, the influence of electromagnetic noise can be curtailed.

### Eleventh Embodiment

An eleventh embodiment will be described. In the explanation below, structural elements that are identical or equivalent to those in the embodiments described above are assigned the same reference numerals, and descriptions of those structural elements are simplified or omitted.

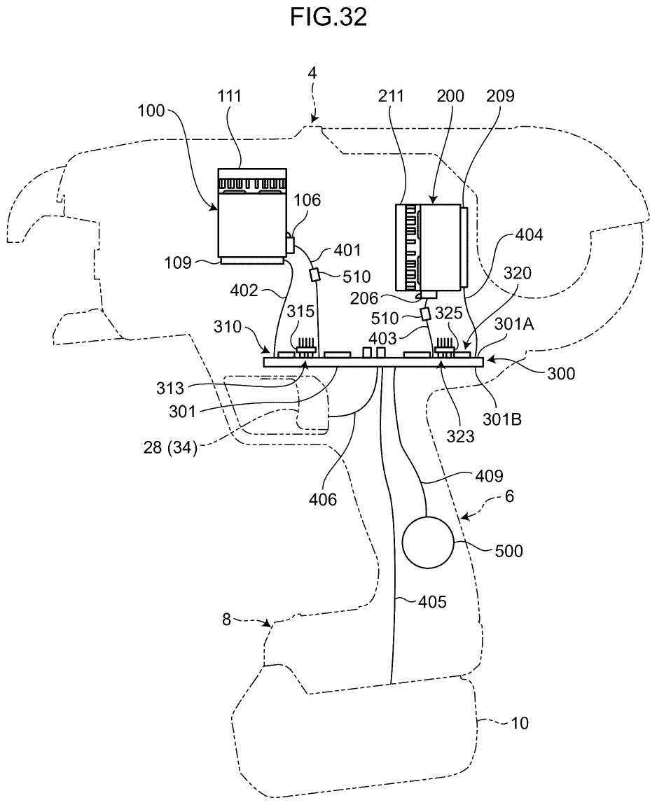

FIG. 32 is a diagram schematically showing a layout example of the controller 300 according to the present embodiment. As compared to the configuration shown in the third embodiment described above, the wireless-communication unit 500, the heat sinks (315, 325), and, further, the noise-removing members 510 are provided in the eleventh embodiment.

The controller 300 is disposed in the head part 4. In the head part 4, the controller 300 is disposed more downward than the feed motor 100 and the twisting motor 200. The controller 300 is disposed in the head part 4 so that the circuit board 301 extends in the front-rear direction. The controller 300 is disposed in the head part 4 so that the first surface 301A of the circuit board 301, on which the first control circuit 310 and the second control circuit 320 are mounted, faces upward. It is noted that the controller 300 may instead be disposed in the head part 4 so that the first surface 301A of the circuit board 301 faces downward.

The circuit board 301 comprises the heat sinks 315, 325, which are thermally connected to at least one of the inverter circuit 313 (the first inverter circuit) and the inverter circuit 323 (the second inverter circuit). In FIG. 32, the heat sinks 315, 325 are provided individually to the inverter circuit 313 and the inverter circuit 323, respectively. The first control circuit 310 is mounted on the forward side of the circuit board 301. The heat sink 315 is provided on the inverter circuit 313 of the first control circuit 310. The heat sink 315 contacts the inverter circuit 313 via a thermally conductive material on the surfaces of the switching elements that constitute the inverter circuit 313. The second control circuit 320 is mounted on the rearward side of the circuit board 301. The heat sink 325 is provided on the inverter circuit 323 of the second control circuit 320. The heat sink 325 contacts the inverter circuit 323 via a thermally conductive material on the surfaces of the switching elements that constitute the inverter circuit 323. Consequently, the heat sink 315 and the heat sink 325 are provided on the first surface 301A side of the circuit board 301.

The wireless-communication unit 500 is disposed in the grip part 6. The wireless-communication unit 500 is connected to the controller 300 via a wired connection. The wireless-communication unit 500 is connected to the second surface 301B of the circuit board 301 via a wired connection by a connecting cable 409. The connecting cable 409 comprises a signal line and a power line. The controller 300 supplies electric power from the battery 10 to the wireless-communication unit 500 via the connecting cable 409. The controller 300 exchanges signals with the wireless-communication unit 500 via the connecting cable 409.

The first surface 301A of the circuit board 301 and the feed motor 100 are electrically connected by the power cables 401. The first noise-removing member 510 is provided on the power cables 401, which supply electric power to the feed motor 100. The first noise-removing member 510 is disposed between the first surface 301A of the circuit board 301 and the feed motor 100. The three electric-power lines (U-phase, V-phase, and W-phase electric-power lines) that constitute the power cables 401 are inserted through the three through holes 511 (see FIG. 27), respectively, of the first noise-removing member 510. The first surface 301A of the circuit board 301 and the twisting motor 200 are electrically connected by the power cables 403. The second noise-removing member 510 is provided on the power cables 403, which supply electric power to the twisting motor 200. The second noise-removing member 510 is disposed between the first surface 301A of the circuit board 301 and the twisting motor 200. The three electric-power lines (U-phase, V-phase, and W-phase electric-power lines) that constitute the power cables 403 are inserted through the three through holes 511 (see FIG. 27), respectively, of the second noise-removing member 510.

The wireless-communication unit 500, the heat sinks 315, 325, and the noise-removing members 510 may be provided in the second embodiment described above.

### Twelfth Embodiment

A twelfth embodiment will be described. In the explanation below, structural elements that are identical or equivalent to those in the embodiments described above are assigned the same reference numerals, and descriptions of those structural elements are simplified or omitted.

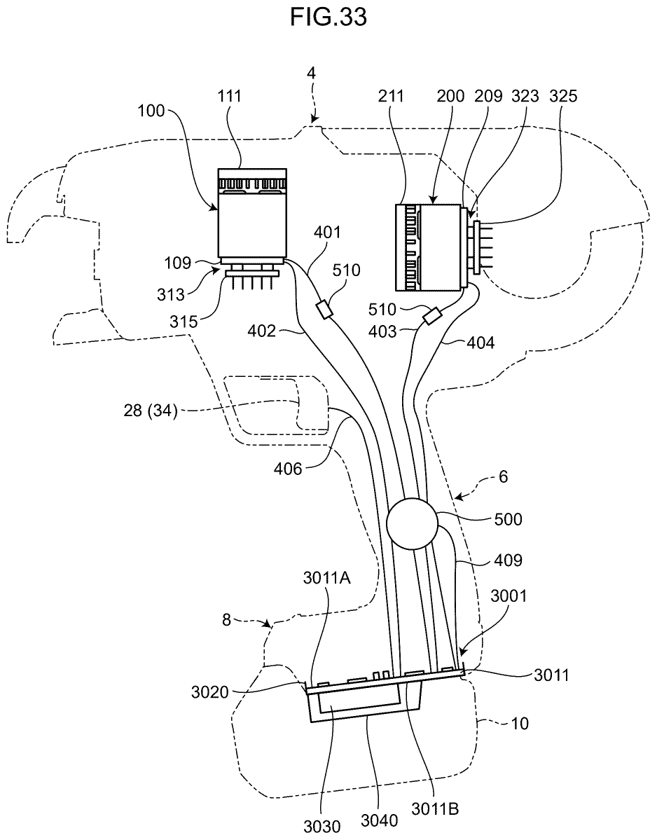

FIG. 33 is a diagram schematically showing a layout example of the controller 3001 according to the present embodiment. As compared to the configuration shown in the ninth embodiment described above, the wireless-communication unit 500, the heat sinks 315, 325, and, further, the noise-removing members 510 are provided in the twelfth embodiment.

The controller 3001 is disposed in the foot part 8. The controller 3001 is disposed in the foot part 8 so that the circuit board 3011 extends in the front-rear direction. The controller 3001 is disposed in the foot part 8 so that the first surface 3011A of the circuit board 3011, on which the first control circuit 310 and the second control circuit 320 are mounted, faces upward.

The sensor board 109 is disposed on the feed motor 100. The inverter circuit 313, which is for controlling the feed motor 100, is provided on the sensor board 109. Consequently, the inverter circuit 313 is not provided on the first control circuit 310. The heat sink 315 is provided on the inverter circuit 313 of the sensor board 109. The heat sink 315 contacts the inverter circuit 313 via a thermally conductive material on the surfaces of the switching elements that constitute the inverter circuit 313. The sensor board 209 is disposed on the twisting motor 200. The inverter circuit 323, which is for controlling the twisting motor 200, is provided on the sensor board 209. Consequently, the inverter circuit 323 is not provided on the second control circuit 320. The heat sink 325 is provided on the inverter circuit 323 of the sensor board 209. The heat sink 325 contacts the inverter circuit 323 via a thermally conductive material on the surfaces of the switching elements that constitute the inverter circuit 323.

The wireless-communication unit 500 is disposed in the grip part 6. The wireless-communication unit 500 is electrically connected to the controller 300 by the connecting cable 409.

The circuit board 3011 and the sensor board 109 are electrically connected by the power cables 401 and the signal cables 402. The first noise-removing member 510 is provided on the power cables 401. The first noise-removing member 510 is disposed between the circuit board 3011 and the sensor board 109. The three electric-power lines (U-phase, V-phase, and W-phase electric-power lines) that constitute the power cables 401 are inserted through the three through holes 511 (see FIG. 27), respectively, of the first noise-removing member 510. The circuit board 3011 and the sensor board 209 are electrically connected by the power cables 403 and the signal cables 404. The second noise-removing member 510 is provided on the power cables 403. The second noise-removing member 510 is disposed between the circuit board 3011 and the sensor board 209. The three electric-power lines (U-phase, V-phase, and W-phase electric-power lines) that constitute the power cables 403 are inserted through the three through holes 511 (see FIG. 27), respectively, of the second noise-removing member 510.

### EXPLANATION OF THE REFERENCE NUMBERS

2 Rebar-tying tool
4 Head part
6 Grip part
8 Foot part
10 Battery
12 Housing
14 Left housing
16 Right housing
16a Screw boss
16b Screw boss
16c Screw boss
18 Side-surface cover housing
18a Cover-holding part
20 Reel-housing chamber
22 Reel cover
22a mounting part
22b Mounting part
24 Reel
28 Trigger
30 Trigger lock
34 Trigger switch
36 Housing mechanism
38 Feed mechanism
40 Brake mechanism
42 Guide mechanism
44 Cutting mechanism
46 Twisting mechanism
54 Cam member
64 Bearing
66 Magnetic sensor
68 Guide member
70 Cover member
74 Speed-reducing mechanism
78 Main driver gear
80 Follower gear
82 Release lever
86 Lock lever
88 Guide pipe
90 Upper-side curl guide
92 Lower-side curl guide
92a Swing shaft
92b Torsion spring
100 Feed motor (first brushless motor)
101 Stator
102 Rotor
103 Rotor shaft
104 Stator core
105 Coil
106 Terminal
107 Rotor core
108 Rotor magnet
109 Sensor board
109A Circuit-board part
109B Support part
110 Magnetic sensor
111 Fan
112 Insulator
113 Balance-correcting plate
114 Output pinion
120 Swinging member
134 Magnetic sensor
136 Open/close detection mechanism
138 Open/close detection member
140 Compression spring
142 Magnetic sensor
146 Solenoid
148 Compression spring
150 Brake member
172 Speed-reducing mechanism
174 Sleeve
176 Pusher
178 Hook
180 Side plate
184 Side plate
188 Elastic cover
190 Elastic cover
200 Twisting motor (second brushless motor)
201 Stator
202 Rotor
203 Rotor shaft
204 Stator core
205 Coil
206 Terminal
207 Rotor core
208 Rotor magnet
209 Sensor board
209A Circuit-board part
209B Support part
210 Magnetic sensor
211 Fan
212 Insulator
213 Balance-correcting plate
214 Output pinion
300 Controller
301 Circuit board
301A First surface
301B Second surface
310 First control circuit
311 Microcomputer
312 Gate-driver circuit
313 Inverter circuit
314 Capacitor
320 Second control circuit
321 Microcomputer
322 Gate-driver circuit
323 Inverter circuit
324 Capacitor
330 Holding part
401 Power cable
402 Signal cable
403 Power cable
404 Signal cable
405 Power-supplying cable
406 Signal cable
409 Connecting cable
1000 Feed motor
1020 Rotor
1021 Retaining tube
1070 Rotor core
1080 Rotor magnet
2000 Twisting motor
2020 Rotor
2021 Retaining tube
2070 Rotor core
2080 Rotor magnet
3000 Controller
3001 Controller
3010 Circuit board
3011 Circuit board
3011A First surface
3011B Second surface
3020 Controller case
3030 Terminal
3040 Guide

1. A rebar-tying tool comprising:
a first brushless motor, which feeds a wire that is wound on a reel;
a second brushless motor, which twists the wire;
a head part, in which the reel, the first brushless motor, and the second brushless motor are disposed;
a grip part, which extends downward from the head part;
a foot part, which is disposed downward of the grip part and to which a battery connects; and
a controller, which controls the first brushless motor and the second brushless motor;
wherein the controller is disposed in the grip part.

2. The rebar-tying tool according to claim 1, wherein the controller comprises a circuit board, which is elongated in a prescribed direction, and is disposed in the grip part so that the circuit board extends in an up-down direction.

3. The rebar-tying tool according to claim 2, wherein:
the controller comprises a first control circuit, which is mounted on the circuit board and controls the first brushless motor, and a second control circuit, which is mounted on the circuit board and controls the second brushless motor; and
the controller is disposed in the grip part so that a first surface of the circuit board, on which the first control circuit and the second control circuit are mounted, faces leftward or rightward.

4. A rebar-tying tool comprising:
a first brushless motor, which feeds a wire that is wound on a reel;
a second brushless motor, which is disposed more rearward than the first brushless motor and twists the wire;
a head part, in which the reel, the first brushless motor, and the second brushless motor are disposed;
a grip part, which extends downward from the head part;
a foot part, which is disposed downward of the grip part and to which a battery connects; and
a controller, which comprises a circuit board extending in a front-rear direction and controls the first brushless motor and the second brushless motor;
wherein:
a first control circuit, which comprises a first gate-driver circuit and a first inverter circuit for controlling the first brushless motor, is mounted on a forward side of the circuit board; and
a second control circuit, which comprises a second gate-driver circuit and a second inverter circuit for controlling the second brushless motor, is mounted on a rearward side of the circuit board.

5. The rebar-tying tool according to claim 4, wherein the controller is disposed in the head part.

6. The rebar-tying tool according to claim 5, wherein the controller is disposed in the head part so that a first surface of the circuit board, on which the first control circuit and the second control circuit are mounted, faces leftward or rightward.

7. The rebar-tying tool according to claim 5, wherein the controller is disposed in the head part so that a first surface of the circuit board, on which the first control circuit and the second control circuit are mounted, faces upward.

8. The rebar-tying tool according to claim 1, wherein:
the first brushless motor comprises a first stator and a first rotor, which is disposed in the interior of the first stator;
the first brushless motor is disposed so that the rotational axis of the first rotor extends in an up-down direction;
a first terminal, which connects a plurality of coils of the first stator, is disposed at a rear portion of the first stator;
a first sensor board, which detects rotation of the first rotor, is disposed more downward than the first stator;
the first terminal and the controller are connected by a first power cable; and
the first sensor board and the controller are connected by a first signal cable.

9. The rebar-tying tool according to claim 1, wherein:
the second brushless motor comprises a second stator and a second rotor, which is disposed in the interior of the first stator;
the second brushless motor is disposed so that the rotational axis of the second rotor extends in a front-rear direction;
a second terminal, which connects a plurality of coils of the second stator, is disposed at a lower portion of the second stator;
a second sensor board, which detects rotation of the second rotor, is disposed more rearward than the second stator;
the second terminal and the controller are connected by a second power cable; and
the second sensor board and the controller are connected by a second signal cable.

10. The rebar-tying tool according to claim 1, wherein:
at least one of the first brushless motor and the second brushless motor has a sensor board, which detects rotation of a rotor; and
the sensor board has an inverter circuit for motor driving.

11. The rebar-tying tool according to claim 1, wherein the controller comprises a circuit board, which comprises: an inverter circuit for motor driving; and a heat sink, which is thermally connected to the inverter circuit.

12. The rebar-tying tool according to claim 4, wherein the circuit board comprises a heat sink, which is thermally connected to at least one of the first inverter circuit and the second inverter circuit.

13. The rebar-tying tool according to claim 1, further comprising a wireless-communication unit, which is provided in the grip part.

14. The rebar-tying tool according to claim 1, comprising a noise-removing member, which removes electromagnetic noise on an electric-power line that connects at least one of the first brushless motor and the second brushless motor with the controller.

15. A rebar-tying tool comprising:
a first brushless motor, which feeds a wire that is wound on a reel;
a second brushless motor, which twists the wire;
a head part, in which the reel, the first brushless motor, and the second brushless motor are disposed;
a grip part, which extends downward from the head part;
a foot part, which is disposed downward of the grip part and to which a battery connects; and
a controller, which controls the first brushless motor and the second brushless motor;
wherein:
the controller is disposed in the foot part; and
the controller comprises: a circuit board; a controller case, which houses the circuit board; and a terminal, which connects the battery and the circuit board.
